(19) United States
(12) Patent Application Publication
(10) Pub. No.: US 2012/0031119 A1
(43) Pub. Date: Feb. 9, 2012

(54) ATMOSPHERIC LAPSE RATE COOLING SYSTEM

(76) Inventors: NADEEM AHMAD, ELK GROVE, CA (US); NAEEM AHMAD, ELK GROVE, CA (US)

(21) Appl. No.: 12/849,650

(22) Filed: Aug. 3, 2010

(51) Int. Cl. F25B 41/00; F25B 29/00; F03D 9/00; F24J 3/08

(52) U.S. Cl. 62/79; 165/45; 165/61; 290/55

(57) ABSTRACT

A heat transfer fluid can be cooled using the atmospheric thermal lapse rate. The heat transfer fluid can be ascended to a predetermined altitude above ground level where a temperature of the atmosphere is less than a temperature at the ground level. The heat transfer fluid can be cooled to a predetermined temperature by heat exchange between the heat transfer fluid and the atmosphere. The heat transfer fluid can then be descended to ground level while inhibiting heat transfer with the atmosphere tending to warm the cooled fluid.

### FIELD OF THE INVENTION

Embodiments of the present invention relate to cooling systems and methods and more specifically to cooling systems and methods based on the atmospheric lapse rate.

### BACKGROUND OF THE INVENTION

Various types of thermal storage systems have been used in the last several decades to store cooling at off peak hours to take advantage of lower electricity rate. At peak electricity rates and demands (during the day light hours) the fully charged thermal storage unit supplies cooling to buildings for refrigeration and or air conditioning depending on the application of the system as well as cooling supplied for industrial processes and applications. In addition to the traditional building cooling requirements for human comfort or preservation of foodstuffs, in recent years a number of indoor ski slopes have been built for recreational purposes, to produce real snow indoors, while taking advantage of thermal storage system to reduce their startup and operating costs. Thermal storage systems translate into huge savings in terms of initial start up capital costs of a much smaller air conditioning/refrigeration unit, since the desired results can be achieved by running this smaller and cheaper unit over a longer period of time. Running the unit during “off peak” electricity rates, also saves money. Taking into account economies of scale, another very big advantage of thermal storage systems are specially those used for indoors ski slopes and large buildings, district cooling plants or building complexes like university campuses etc. Indoors ski slopes require a very large amount of cooling in a very short period of time i.e. during snow making operations of say 2 to 4 hour a day. To supply the required heavy cooling load through conventional means normally an over sized refrigeration plant would have to be installed that would run on maybe 10 to 15% of the capacity during normal hours of operations of 20 to 22 hours a day. With the huge stored cooling capacity of a thermal storage unit, the required cooling at high cooling demand periods in the indoor ski slopes may be supplied by thermal storage unit and not the over sized refrigeration unit. Therefore, due to the thermal storage unit, the size of refrigeration unit needed can be reduced to ⅛^{th} or 1/20^{th} of the required size. It is very clear that as a result of the thermal storage unit, the cooling load which would normally be (for a given size) during snow making operations of say 1,200 Kw can be reduced by up to 20 times to only 60 Kw. Snow making for indoor ski slopes is described, e.g., in U.S. Pat. Nos. 5,230,218 and 7,062,926, the entire contents of both of which are incorporated herein by reference. The combination of using a much smaller refrigeration unit along with running it for longer periods of time during periods of low electricity rates may be very cost effective in terms of much lower initial startup capital cost of the refrigeration plant coupled with usage of lower “off-peak” electricity rates thus saving the operator substantially on ongoing operating cost for storing huge amount of cooling to be used later.

Current air conditioning/refrigeration and thermal storage systems are typically based on a conventional refrigeration cycle in which a refrigerant (typically, a gas) may be compressed. Heat may be extracted from the compressed gas. In some cases, the compressed gas may condense into a liquid. The cooled compressed gas may be then allowed to expand whereupon it cools even further. The cooled gas may be used for air conditioning or refrigeration and then the cycle repeats. Unfortunately, the compression of the refrigerant requires a significant amount of energy, much of which may be derived from hydrocarbon based fuels such as coal, oil, and natural gas.

Due to convenience of use and low cost, widespread use of hydrocarbon based non-renewable sources of energy may be believed to have led to a major negative impact on our environment and has resulted in, among other things, severe climate changes that are getting worse each day and rapidly destroying this planet. It would be desirable to satisfy the growing energy demands of mankind while drastically reducing the negative environmental impact and carbon footprint on our planet as a result of using existing hydrocarbon based technologies.

To reduce dependence on hydrocarbon-based fuels and to reverse or slow down the environmental damage due to use of these fuels new and innovative technologies are being sought while the use of existing renewable energy technologies may be growing at an unprecedented rate. However, these technologies are still in their infancy stage and are very expensive with relatively low return on investment. Improvements and new discoveries are being made to increase the efficiency of current renewable energy systems with very limited success if any. Renewable energy technologies are currently in an infancy stage and have a very long way to go before they are economically at par or lower in terms of cost with conventional methods. Cost to produce these systems and the cost to produce power as a result of their operations are very high (in some cases as much as 4 to 5 times more) and the return on investment may be low and drawn out over a long period of time; in the case of photovoltaic cells and wind turbines it may be as long as 25 years before the initial investment is recovered. Large amounts of capital investment are required in research & development, infrastructure and other costs associated with these technologies.

The main renewable energy systems currently in use are; Wind, Solar, hydropower, geothermal, biomass and bio-fuels etc. These technologies require huge amounts of capital investments and in most case have a negative environmental impact as well as encroachment on and destruction of wild life habitats, since large area of land have to be utilized to install and operate each system. Bio-Fuels based technologies require huge amounts of land and already scarce water resources to grow the crops that would be turned into bio-fuels. In addition to this bio-fuels require substantial labor and infrastructure to achieve the desired results. Renewable energy systems cannot be installed just anywhere, special areas have to be selected to ensure there may be enough wind for wind power, irrigation water for bio-fuel crops and sun light for solar farms and in case of hydropower large and sustained sources of water and dam-able area, hydropower has reached its maximum potential as all the rivers that could be dammed are already dammed. This may be also the case for solar-power, solar farms require square mile after square mile of land in order to be viable, highly specialized and complex installation requirements have to be met before it becomes operational. Once a solar farm may be operational pesticides have to be sprayed regularly to keep vegetation from growing so as to eliminate fire hazard conditions right under very expensive solar panels and equipment and this translates into negative environmental impact. Crews have to be on constant watch looking after the installed assets to ensure there are no problems. Land selection and acquisition alone adds large amounts of capital to the project. After all the money may be spent on research and development, production, distribution, transportation and finally installation of the above systems one may be highly dependent on weather conditions that are beyond every ones control, this has a direct impact on production, if there is an extended cloud cover the solar cells can not produce the much needed power. In the case of wind farms, if there is no wind the wind turbines remain idle; losing revenue. In the case of hydropower if there is not enough precipitation or there is a drought then hydropower may not be produced. When these weather conditions are encountered, coal burning or other fossil fuel burning plants have to work extra hard to satisfy the added demand which translates into higher carbon emissions which in turn adds to global warming.

It is within this context that embodiments of the present invention arise.

### SUMMARY OF INVENTION

Embodiments of the present invention related to apparatus and methods to store or transfer cooling from high altitude ambient air to the ground to be used for air conditioning and refrigeration as well as industrial processes purposes. Mobile thermal storage units can be lifted to high altitude by various means like lighter than air gas filled balloons, gliders, kites or aircraft or combinations of Also fixed structures like ultra tall towers or buildings to can be purpose built to circulate air/gas or some other heat transfer fluid from ground level to the top of the structure to be cooled and back to the ground to be used for cooling purposes. Embodiments of the invention take advantage of the decrease in atmospheric temperature with increase in altitude or “Lapse Rate”, to transfer cooling from high altitudes to the ground by various means.

Embodiments of the invention avoid the use of traditional refrigeration equipment and refrigeration cycle and their associated disadvantages. Instead a new type of cooling system that may be environmentally friendly and may be 100% renewable, 100% efficient and may be available above ever square inch of the planets surface is used. A major global effort is underway to find new forms of renewable energy as well as to more efficiently harness those that have been discovered already (i.e. solar, wind etc).

One of the problems solved by the proposed systems and methods is that they are not dependent on weather or environmental conditions except for in very rare and severe weather conditions. Furthermore, such systems and methods do not require a large area of land. Depending on the size of the operation, such a system may utilize an area as small as two acres or as large as a commercial airport, from which hundreds of balloons or many aircraft may be launched simultaneously. Furthermore, such systems and methods drastically reduce or virtually eliminate the consumption of electrical power to produce the cooling while completely eliminating expensive refrigeration plants or air conditioning units and the possible dangerous refrigeration gas leaks associated with such systems. The losses of power as a result of transmission, distribution (estimated to be 7%) and conversion from one form of usable energy to another can also be drastically reduced or virtually eliminated with the proposed system. For example when electricity is used to produce cooling at least 2.5% of the power is lost due to friction and conversion. This new system virtually eliminates these losses since no power of any kind may be used to produce cooling. With this system there may be very little if any direct consumption of any electricity produced by fossil fuels of any kind to lift the cargo of thermal storage containers to desired altitude and back. Lighter than air gas used for buoyancy can be used over and over again with only very minimal replenishment of gas to make up for losses due to rare but possible leaks. The only cost is of surface transportation of the fully charged containers or tanks of cooled heat transfer fluid to their destination to be hooked up and the discharged container brought back to be charged up and redelivered to clients. If district cooling is being supplied than the containers only have to be transported within the yard hooked up and the cooling supplied via distribution line, cost of pumping which are present anyway, with current district cooling systems would be insignificant compared to how much it would cost to run refrigeration equipment to achieve the desired cooling.

The balloons can have equipment to meet all FAA (federal aviation administration) safety requirements in U.S.A and equipment to comply with aviation laws of each county it is being deployed in, and may be equipped with transponders and other safety equipment like anti collision strobes and lights so aircraft can not accidentally fly into the tethers or the balloons or the balloons may be launched and be under direct air traffic control. The balloons can be launched from within specially designated no fly zones or only during night time when commercial, military and general aviation traffic may be at a minimum.

Balloons may also be launched from ships close to shore or out to sea to store cooling in individual containers or to turn the entire ship into a large thermal storage vessel by chilling/freezing water being held in its storage tanks. Once fully charged the ship would be brought back to shore where cooling can be supplied to shore as needed. Alternatively regular cargo ships can use the technology during their voyage to supplement their cargo.

### BRIEF DESCRIPTION OF DRAWINGS

Referring now to the drawings in which like reference number represent corresponding parts throughout.

FIG. 1A is a schematic of a lighter than air gas filled balloon with 3 containerized type thermal storage units attached to it just under the lifting frame assembly and equipment compartment.

FIG. 1B is a schematic of a lighter than air gas filled balloon and over sized kite attached to it to increase or supplement its lifting capacity.

FIG. 2A illustrates a cutaway of side view of thermal storage unit showing interior and exterior heat exchanger pipes.

FIG. 2B is an illustration of a cutaway of front view showing interior and exterior pipes of the thermal storage unit.

FIG. 2C is an illustration of exterior side view of thermal storage unit showing exterior heat exchanger pipes and wind powered re-circulating pump.

FIG. 2D illustrates exterior front view showing, quick disconnect inlet and outlet ports and wind driven propeller attached to a circulation pump.

FIG. 2E illustrates thermal storage unit hooked up to a building supply and return lines and building heat exchanger unit.

FIG. 2F is a schematic of a cooling circuit showing interior and exterior heat exchangers of a mobile thermal storage unit hooked up to a building heat exchanger and forced air blower system.

FIG. 3 is a thermodynamic diagram illustrating the relationship between temperature and altitude. (Source:—http:www.// Wikipedia.org)

FIG. 4A is a flow chart depicting the steps involved in launching and recovery of a lighter than air gas filed balloon.

FIG. 4B is same as FIG. 4A, with the exception that a balloon and kits combination is shown.

FIG. 5A is a depiction of a ultra tall tower/building to be used as a platform for mounting of wind powered generator and solar panels, where at lease one of the generator is used to drive the pump which can pump heat transfer fluid from ground level to the massive heat exchanger unit located some where along the tower, in this case it is shown at the top of the tower, also shown are various other items.

FIG. 5B is a top view of the ultra tall tower as depicted in FIG. 5A.

FIG. 6A is a schematic diagram of an atmospheric cooling system according to an embodiment of the invention that uses balloons to support a heat exchanger, and an air circulating system.

FIG. 6A-1 is a top view of a balloon cluster and equipment platform of FIG. 6A.

FIG. 6A-2 is a side view of the balloon cluster and equipment platform of FIG. 6A.

FIG. 6A-3 is a top view of equipment platform and balloon mounting frame of FIG. 6A.

FIG. 6A-4 is a bottom view of FIG. 6A-3

FIG. 6B is a depiction of a cooling system similar to the system described in FIG. 6A with an additional liquid circulation system to transfer cooling to the ground,

FIG. 6B-1 is a top view of the balloon cluster and equipment platform of FIG. 6B.

FIG. 6B-2 is a side view of the balloon cluster and equipment platform of FIG. 6B.

FIG. 6B-3 is a top view of equipment platform and balloon mounting frame of FIG. 6B.

FIG. 6B-4 is a bottom view FIG. 6B-3.

FIG. 6C is a depiction of a cooling system similar to the system described in FIG. 6B where the air circulating system has been removed and only the water or liquid circulating system is left in place.

FIG. 6C-1 is a top view of the balloon cluster of FIG. 6C.

FIG. 6C-2 is a side view of the balloon cluster and equipment platform of FIG. 6C.

FIG. 6C-3 is a top view of an equipment platform and balloon mounting frame from FIG. 6C.

FIG. 6C-4 is a bottom view of FIG. 6C-3.

FIG. 6D is a view of an air and liquid circulating system similar to FIGS. 6A, B & C with a different type of a main balloon and only a single larger or 2 side-by-side smaller balloons at each equipment platform.

FIG. 6D-1 is a top view of 2 side-by-side smaller balloons attached to an equipment platform of FIG. 6D.

FIG. 6D-2 is a side view of balloon and equipment platform of FIG. 6D

FIG. 6D-3 is a top view of an equipment platform from FIG. 6D.

FIG. 6D-4 is a bottom view of the equipment platform of FIG. 6D-3.

FIG. 6D-5 is a top view of a type of a single larger balloon of an equipment platform of FIG. 6D, showing a pass through opening in the balloon for various air ducts, liquid lines, cables and tether to be able to pass through the balloon.

FIGS. 7A-7C are perspective views illustrating alternative freighter aircrafts with built in cooling systems.

FIG. 7D is a perspective view illustrating the unloading or loading of the fluid between a freighter aircraft and tanker trucks on the ground.

FIGS. 7E-7F are side views of the alternative cooling systems (heat exchangers units) of the freighter aircraft.

FIG. 7G is a top view illustrating unloading the fluid between a freighter aircraft and tanker trucks on the ground.

FIG. 7H is a top view illustrating loading/unloading the fluid between a freighter aircraft and a purpose built specialized terminal building to handle and store chilled and liquid to be chilled on the ground.

FIG. 7I is a side view illustrating loading/unloading the fluid between an aircraft and a cooling system built under the ground.

FIG. 7J is a schematic illustrating an external or internal heat exchanger of a freighter aircraft coupled to a thermal storage tanks inside the freighter aircraft.

FIG. 8A is a schematic diagram of an atmospheric cooling system according to an embodiment of the invention that uses balloons to support a heat exchanger, and an air and heat transfer liquid circulating system as depicted in FIG. 6D with the system in this arrangement positioned on a vessel floating on the ocean in accordance with an alternative embodiment of the present invention.

FIG. 8B is a close up of a section of the system in FIG. 8A.

FIG. 9 is a schematic diagram of an atmospheric cooling system similar to that shown in

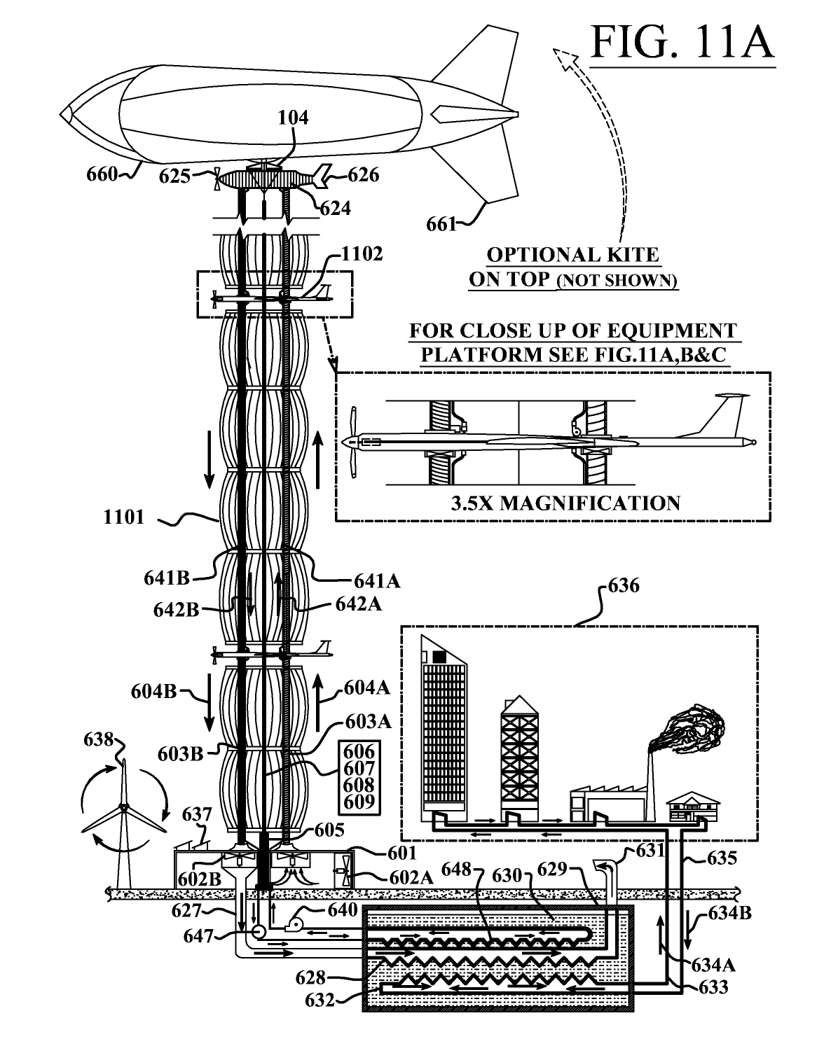

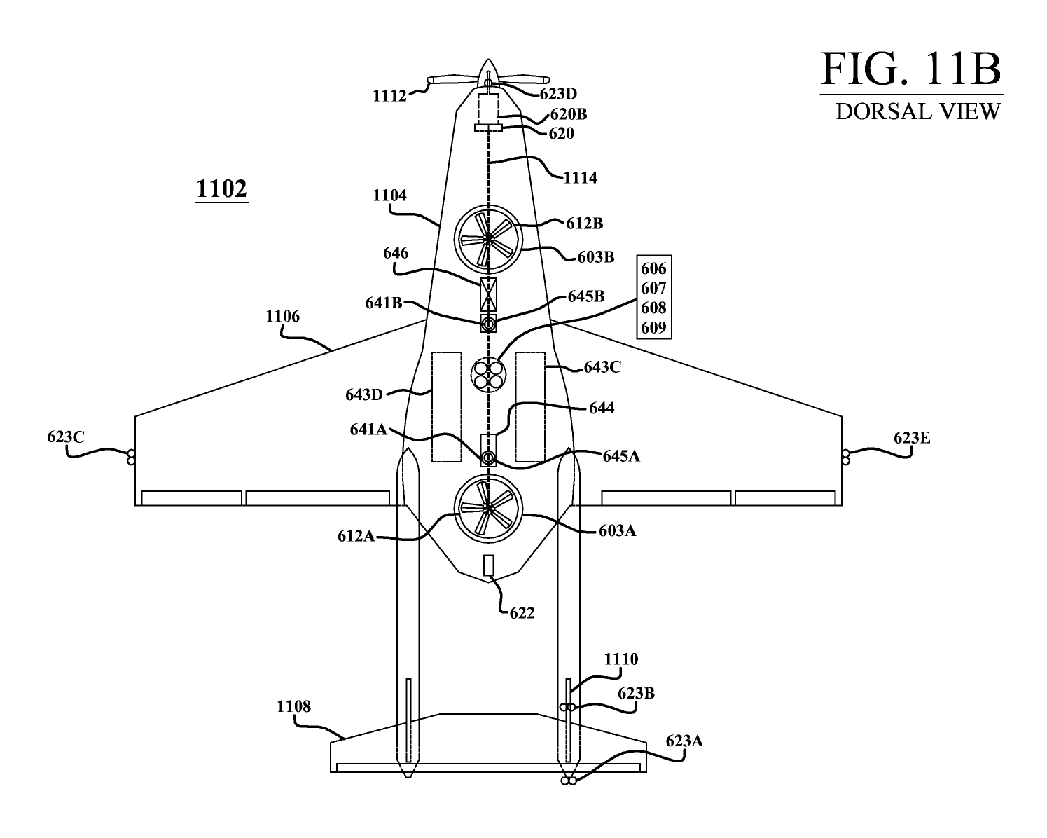

FIG. 8A except in this arrangement the system is attached to and launched from a platform built above a water surface of the ocean in accordance with an alternative embodiment of the present invention.

FIGS. 10A-10B is a schematic diagram of western and eastern hemispheres of the Earth illustrating the variation of the depth of the troposphere with varying latitude.

FIG. 11A is an alternative atmospheric cooling system according to an embodiment of the invention that uses self lifting equipment platforms and self lifting duct and piping system.

FIG. 11B-D are various views and schematic diagrams of self lifting equipment platform of FIG. 11A.

### DETAILED DESCRIPTION OF THE INVENTION

### Technical Field

The present disclosure relates generally to a system and method of providing space and refrigeration cooling without the consumption of electricity or use of conventional refrigeration equipment to achieve desired temperatures (a first and one of a kind technology in the world) the method can be called mining the atmosphere for its cold or “atmospheric mining”. The mobile and easily transportable thermal storage units can be lifted up to medium to high altitudes of say between 10,000 to 36,000 feet or even higher by a lighter than air gas filled tethered or self-propelled un-tethered balloon, preferably a Helium filled balloon. In another embodiment a combination of lighter than air gas filled balloon and a large kite attached to the top of the balloon maybe used, whereby, the kite can add greatly to the lifting capacity of the gas filled balloon, the two working in concert with each other.

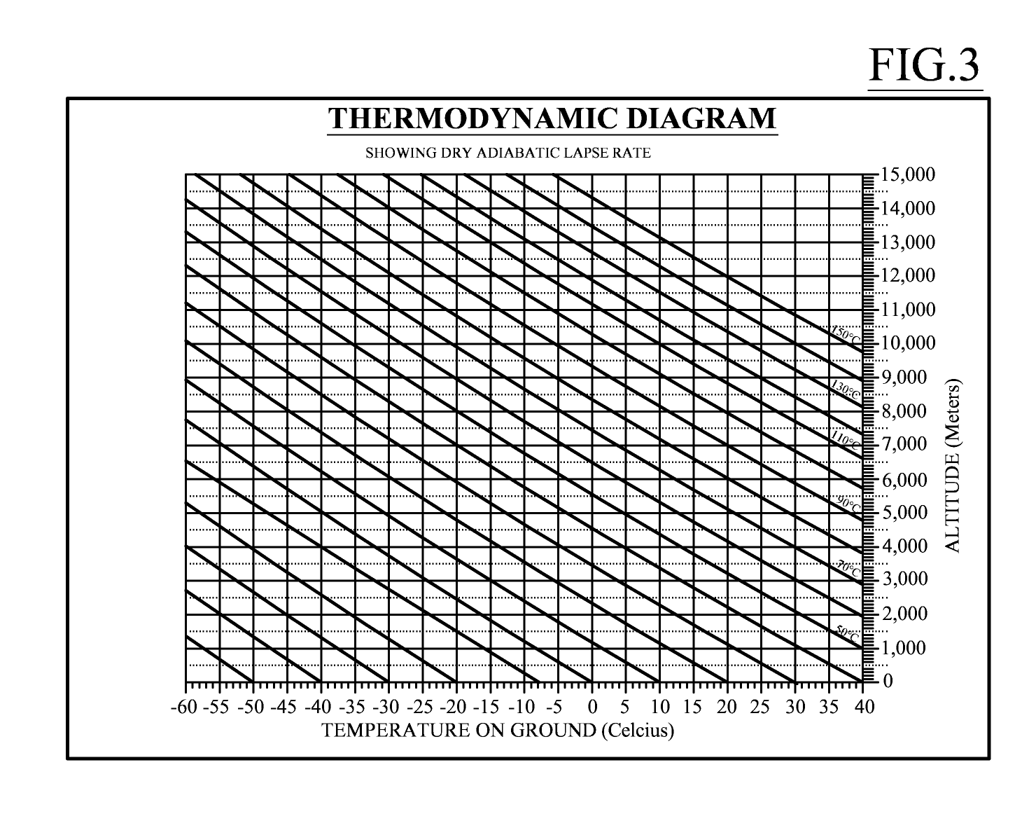

Atmospheric “Lapse Rate” is defined as negative of the rate of change in atmospheric variable, usually temperature, with height in an atmosphere with negative increase or decrease of temperature as the altitude increases or decreases at specific time and place and at standard pressure and temperature (see http://en.wikipedia.org/wiki/Wind_chill). FIG. 3 is a temperature, altitude, pressure and mixing ratio graph depicting the relationship between temperature, pressure, mixing ration and altitude. (Source:—http:www.// Wikipedia.org).

As an average, the International Civil Aviation Organization (ICAO) defines an international standard atmosphere (ISA) with temperature lapse rate of 6.49° C./1,000 Meters (decrease of 3.56° F. or 1.98° C. for every 1,000 Feet gain in altitude. This rate is constant from sea level to an altitude of 11 km (36,090 ft). γ=−dT/dz, where γ is the adiabatic lapse rate given in units of temperature divided by units of altitude, T=Temperature, and z=altitude. So at 36,000 feet the temperature is −60° C. or −76° F. High wind speeds at such altitudes may enhance the rate of cooling. To take advantage of all of this free cooling, heat transfer can take place via an external and internal heat exchanger unit attached to the thermal storage unit or heat exchanger unit.

The Lapse Rate referred to above is sometimes known as the environmental lapse rate (ELR), which is defined as the rate of decrease of temperature with altitude in the stationary atmosphere at a given time and location. The environmental lapse rate is different from the dry adiabatic lapse rate and the moist adiabatic lapse rate. An unsaturated parcel of air of given temperature, altitude and moisture content below that of the corresponding dewpoint cools at the dry adiabatic lapse rate as altitude increases until the dewpoint line for the given moisture content is intersected. As the water vapor then starts condensing the air parcel subsequently cools at the slower moist adiabatic lapse rate if the altitude increases further.

The dry and moist adiabatic lapse rates are defined differently and depend on several factors, as illustrated in the graph shown in FIG. 3. In FIG. 3, the solid lines represent dry adiabats which show the variation in temperature for a rising or sinking parcel of dry air having a given temperature at ground level.

Specifically, the dry adiabatic lapse rate (DALR) is the rate of temperature decrease with height for a parcel of dry or unsaturated air rising under adiabatic conditions. Unsaturated air has less than 100% relative humidity; i.e. its actual temperature is higher than its dew point. The term adiabatic means that no heat transfer occurs into or out of the parcel. Air has low thermal conductivity, and the bodies of air involved are very large, so transfer of heat by conduction is negligibly small. Under these conditions when the air rises (for instance, by convection) it expands, because the pressure is lower at higher altitudes. As the air parcel expands, it pushes on the air around it, doing work. Since the parcel does work but gains no heat, it loses internal energy so that its temperature decreases. The rate of temperature decrease is 9.8° C. per 1,000 m. (The reverse occurs for a sinking parcel of air).

When the air is saturated with water vapor (at its dew point), the moist adiabatic lapse rate (MALR) or saturated adiabatic lapse rate (SALR) applies for rising or sinking parcels of air. This lapse rate varies strongly with temperature. A typical value is around 5° C./km (2.7° F./1,000 ft). The reason for the difference between the dry and moist adiabatic lapse rate values is that latent heat is released when water condenses, thus decreasing the rate of temperature drop as altitude increases. This heat release process is an important source of energy in the development of thunderstorms.

As the balloon ascends it lifts with it one or more attached mobile thermal storage units. Heat transfer can be initiated at a pre-determined ambient temperature/altitude via signals from a controller hooked up to a thermostat or an altimeter or a combination of the two, activating a pump. An internal combustion engine, electric motor, hydraulic motor, solar or wind powered or ram air circulating pump can then commence re-circulating of an efficient heat transfer fluid/coolant say i.e. water with freezing point depression agent to keep it in liquid form or Ethylene Glycol between the external and internal heat exchangers. The insulated tank or vacuum flask type container can be filled with thermal storage medium of say water with freezing point depression agent to inhibit freezing until it reaches very cold temperatures of say, same as the temperature of the outside atmosphere, mass of relatively high conductivity material mixed into the water, like aluminum oxide or a combination of a small ratio on the order of 5% to 10% of water to thermally conductive material and a small ratio of insulator again the ratio being around 5% to 10% like saw dust or insulating material by itself can help achieve faster cooling as the heat from the water or thermal storage medium can be absorbed by the thermally conductive material therefore, allowing for faster cooling. And in the case of the insulating material only the already cold liquid can be insulated for faster cooling. Similarly, once frozen or super cooled if only insulating material is mixed with the heat transfer fluid, the insulating material can help preserve the cooling capacity of the heat transfer fluid for longer periods. The thermal storage medium tank can have an internal heat exchanger, e.g., coiled piping running through it carrying the heat transfer fluid. As the heat transfer fluid is circulated it can absorb the heat from a thermal storage medium inside the tank and carry it to the outside of the tank to dissipate the heat into the ambient atmosphere. Heat from external heat exchanger piping can get absorbed into the surrounding cold atmosphere causing the temperature of the heat transfer fluid to drop to same or near the ambient temperature at that altitude. As the heat transfer fluid is circulated over and over again from inside the tank to the outside the thermal storage medium can eventually achieve the same temperatures as the temperature of the outside atmosphere. Once the thermal storage unit is fully charged by achieving the desired temperature the controller can direct the re-circulation pump to stop while closing the inlet and outlet valves, thereby, isolating the thermal storage medium contained inside the tank from the outside to preserve the temperature of the thermal storage medium inside the tank. At this point the gas in the balloon envelope can be pumped into an interior holding tank causing the balloon to become less buoyant, thereby, putting the balloon into a controlled descend back to the ground as the balloon descends the tether can be reeled back into its spool. Another way to make the balloon less buoyant would be to ingest outside air into bladders in the balloon thus making it less buoyant, reduced buoyancy of the balloon can put the balloon into a controlled descend. Yet another way to make the balloon descent may be to change the size or volume of the balloon by increasing or decreasing the envelope of the balloon using various methods. Or the balloon tether can simply be reeled in, back into its spool, pulling the balloon to the ground. It is important to point out that during the ascent portion of the flight otherwise a traction phase of the tether, it can be connected to a power extractor used to turn a generator thus producing electricity. Once on the ground fully charged mobile thermal storage containers can be released and new containers can be hooked up for another round trip to high altitude and back. The cycle can be repeated as often as once every hour for a round trip to 20,000 ft altitude depending if cooling of say, minus −17.8° C. or minus −20° F. is desired. If less cooling is desired, ascend can be to lower altitude if more is desired than ascend can be to altitudes of say 36,000 feet where, as stated earlier, generally atmospheric temperature is in the minus −60° C. or minus −76° F. range.

### Embodiments

In the following description of the following embodiments, reference is made to the accompanying drawings that form a part hereof, and in which is known by way of illustration a specific embodiment in which the invention may be practiced. It is to be understood that other embodiments may be utilized or combinations, thereof, and structural changes may be made without departing from the scope of the present invention.

### Overview

Thermal storage systems have been used for years to store cooling during off peak hour to take advantage of reduced electrical rates and then supply the stored cheaper cooling during peak hours. The high cost of electrical power and the negative impact electricity production and consumption has caused on the planet forced engineers to come up with ways to reduce the cost of cooling and the demand on utilities as cooling loads during peak hours account for a significant draw of electricity. Cooling of buildings in some instances accounts for as much as 50% of the total peak demand, especially in hot and humid regions of North America and as much as 70% of total cooling load of a building in the Middle East region of the Arabian peninsula. Thermal storage systems remedy this problem to a certain extent by shifting the electrical load required for cooling to off peak hours or lower electrical tariff periods during each day or night time. Ice is made and stored during the “off peak” periods, usually at night at much lower per kilowatt hour costs, but the overall electrical requirements have always been around the same amount due to the smaller plants running for a longer period, basically the carbon emissions as a result of electricity production remain the same as they are only shifted at different time of the day. Essentially by this method the total energy used may be the same the only advantage is using the required energy at cheaper “off peak” periods translates into monetary sayings and not energy savings or carbon emission savings. Stored ice may be used to supply cooling day or night during periods of high demand. Depending on the region of the world, as stated earlier air conditioning and refrigeration accounts for anywhere from 25% to 70% of total electricity consumption, whereas in the Middle East as much as 60% to 70% of electricity consumed by a building goes towards satisfying its cooling load. Significant amounts of electrical power are required for cooling purposes. Up until now typical systems have successfully achieved the goals of somewhat lowering the electrical consumption due to better and more efficient designs, thus marginally reducing the carbon foot print on the environment while realizing some savings. In addition to electrical consumption a great deal of money has to be spent up front on refrigeration equipment and the on going maintenance expenses associated with running the equipment.

Embodiments of this invention greatly reduce or virtually eliminate the capital costs associated with purchase and installation of air conditioning and refrigeration equipment and the associated on going operating and maintenance costs by eliminating the refrigeration cycle. Therefore, elimination of a conventional refrigeration cycle translates into no conventional refrigeration equipment needed, which is the very heart of the cooling system. The only costs associated with this system are the distribution costs of the chilled liquid once cooling is achieved. Distribution costs of the chilled liquid with current systems are paid in any case with district cooling methods in operation around the world. For example in the case of a district cooling plants after cooling is achieved the cold medium or heat transfer fluid has to be pumped to its destination to cool the space it is destined for, that cost can be constant for this system. No harmful refrigeration gases are used, which eliminates the possibility of refrigerant gas leaks into the atmosphere and this in turn makes this technology much safer and more environmentally friendly.

A lighter than air gas, e.g., helium, may have the following properties at standard pressure and standard temperature:

One Cubic foot of Helium has a lifting capacity of 28.20 grams. A 200 foot diameter balloon has a volume of 4,186,667 cubic feet, once filled with helium it can have a lifting capacity of around 131.77 tons. After deducting the weight of the balloon and the equipment, anticipated to be no more than 5 to 10 tons, there may be a tremendous weight that can be lifted for virtually zero energy consumption. Alternatively, designs or configuration of balloon and kite combination working together can help accomplish one of 2 things, (1) reduce the size of the balloon and quantity of lighter than air gas, where the kite's lifting capacity makes up for the reduced lifting capacity of a smaller balloon and (2) Balloon and kite combination can greatly increase the lifting capacity of a given size of a balloon as well as during the traction phase (ascending leg) the combination of the two can generate a greater force on the tether which in turn can yield significant amounts of harnessable power by the power extractor the line is hooked up to.

Alternatively to the balloons or balloons plus kite combinations, large cargo aircraft can be used to lift removable containers or cooling liquid stored in permanent tank aboard each aircraft to desired altitudes and back down to the ground again. Cargo aircraft are traditionally designed to fly from point A to point B at much higher speeds than surface transports. Large quantity of fuel has to be carried for the trip. For example a full fuel load in the case of a Boeing 747-300 is over 150 metric Tons and a payload carrying capacity of about 96 metric Tons can account for revenue-generating payload of passengers and cargo or cargo along in the case of freighter version. The fuel load drastically cuts into revenue generating payload, fuel load being a necessary expense. For this system the advantage of using aircrafts is that the departure point is the same as the arrival point. Only a short trip has to be made with minimum possible fuel load to desired altitude and back down again, majority of fuel being spent during the ascent leg of the flight, which is anticipated to be no more then 30 minutes in duration. The over 150 metric tons of fuel load that does not need to be carried can be replaced with thermal storage medium, e.g., containers or cooling liquid in converted fuel tanks throughout the aircraft. Once on the ground, a quick unload of charged container and loading of containers to be charged can take place via quick disconnect and quick connect couplings. While this unloading and loading operation is going on the aircraft can be refueled with just enough fuel load for another round trip to planned altitude.

Alternatively the contents of the cargo aircraft, i.e., super cold liquid may be off loaded via a gravity feed or a pressurized system into ground holding and distribution tanks or onto tanker transport trucks. Using a pressurized system aboard the aircraft can facilitate very rapid off loading of super cold liquid and subsequent loading of liquid to be cooled next, with the help of pressurized system the loading and unloading can be accomplished in second or minutes depending on the quantity, affording a much quicker turn around of the aircraft which in turn can facilitate more cycles per given 24 hour period. In one embodiment the aircraft may be equipped with external heat exchanges installed on the outside surfaces of the airframe, heat transfer liquid can circulate taking heat out of storage containers' thermal storage medium and venting it to the outside atmosphere to cool the thermal storage medium. In another design, aircraft could have ram air ports/scoops that can be configured to bring cold outside air to heat exchanger installed inside the aircraft to take out heat and input cold into the thermal storage medium. As the aircraft ascends, pumps that circulate the heat transfer fluid can be turned on. By the time the aircraft reaches the desired altitude the drop in atmospheric temperature and the gradual heat transfer taking place through out the ascent would enable the aircraft to maintain level flight at planned altitude only for a very short period of time to achieve the temperatures in the thermal storage medium to same levels as the outside atmosphere. It is important to point out that due to the high velocity of the aircraft on the order of several hundred miles an hour the heat transfer can take place at a much higher rate as opposed thermal storage containers being lifted aloft by balloons, therefore, the freighter aircraft would have to spend minimum time at planned altitude if any before returning with it's cargo of thermal storage medium that is reduced to a desired temperature. Once the desired temperature is achieved, the controller could close isolation valves to maintain the stored cooling in the thermal storage medium. A quick descent and landing back at the departure point can be made and the whole process can be repeated over and over. It is estimated that it would take no more than 30 minutes for the aircraft to reach 36 thousand feet to achieve stored super cooling in the order of minus −60° C. or minus −76° F. range to be used later on the ground. The amount of jet fuel expanded to super cool it's liquid cargo on board would be considerably less than the energy expanded to make electricity that in turn would have been transmitted long distances using expensive infrastructure to be used by expensive air conditioning and refrigeration equipment used to achieve the super cooling at the same level, translating into considerable savings. Pound for pound this system would emit only one third of the carbon dioxide into the atmosphere as compared to burning coal, since burning jet fuel is better then burning coal in coal fired plants that generate the required electricity. Existing aircraft can be retrofitted with the proposed system or new purpose built aircraft may be manufactured with the proposed system.

After charged containers are off loaded from balloons or aircraft they can be transported to district cooling plants, or buildings to be hooked up to the end users' cooling systems. For smaller customers like residential users who are not hooked up to district cooling grid, large containers can be used to charge many smaller containers which would than be delivered to individual households and swapped out with discharged containers just like delivery of bottled water, where full bottles are delivered and empties are picked up to be filled back at the plant.

New housing, commercial and industrial developments can benefit from having a central neighborhood cooling supply facility to supply cooling through underground insulated pipes, to individual homes and businesses. Existing housing and commercial and industrial customers may also benefit from retrofit of central neighborhood supply plants for their cooling needs, in similar distribution fashion as gas and water lines, chilled coolant line may be installed to service these customers.

Alternatively, instead of lighter than air gas filled balloons or aircraft, winged lifting devices/bodies, large kites or combination there off, ultra high permanent structures like buildings or towers could be constructed to heights of 1 to 4 miles (1.60 to 6.44 Kilometers). The proposed structures can be purpose designed and built to house ductwork and or liquid supply and return lines that would circulate forced air or heat transfer fluid, through its ducts/piping system to higher altitudes where the circulated air or heat transfer fluid would be cooled or super cooled upon passing through heat exchangers on the top, than pumped back to the ground for cooling purposes. On the downward leg, the return piping could be hooked up to turbines that turn electrical generators at specific intervals to generate electricity. To control the pressure head on the supply (ascending) piping and return (descending) lines liquid storage tanks could be installed to hold the liquid to be pumped through the lines above it to the next liquid storage tank above it, located at a predetermined distance. Depending on height of the structure as a result of going through heat exchangers at the top and back to ground level various temperatures may be achieved to supply direct cooling to end users. Cooling from high altitude can be used to either supply forced chilled air/chilled liquid for space cooling or to freeze large insulated or under ground reservoirs of water or a mixture of water plus freezing point depression agents to be used as thermal storage units that would than supply cooling to commercial, residential or industrial customers as needed. Alternatively heat transfer fluid can be circulated via piping to the top of the structure to be cooled and then pumped back to the ground to supply direct cooling of interior spaces or to make large amount of ice or charge thermal storage systems that can than be used to supply cooling as and when needed. Power to pump the fluids or the forced air would be supplied by wind and solar powered pumps spaced at differed intervals of the structure thereby harnessing the wind or solar power or both. In addition to the wind and solar power, falling liquid on its downward leg can be used to generate power by running the falling water through a turbine wheel that drives a generator.

### Technical Description Of Drawings

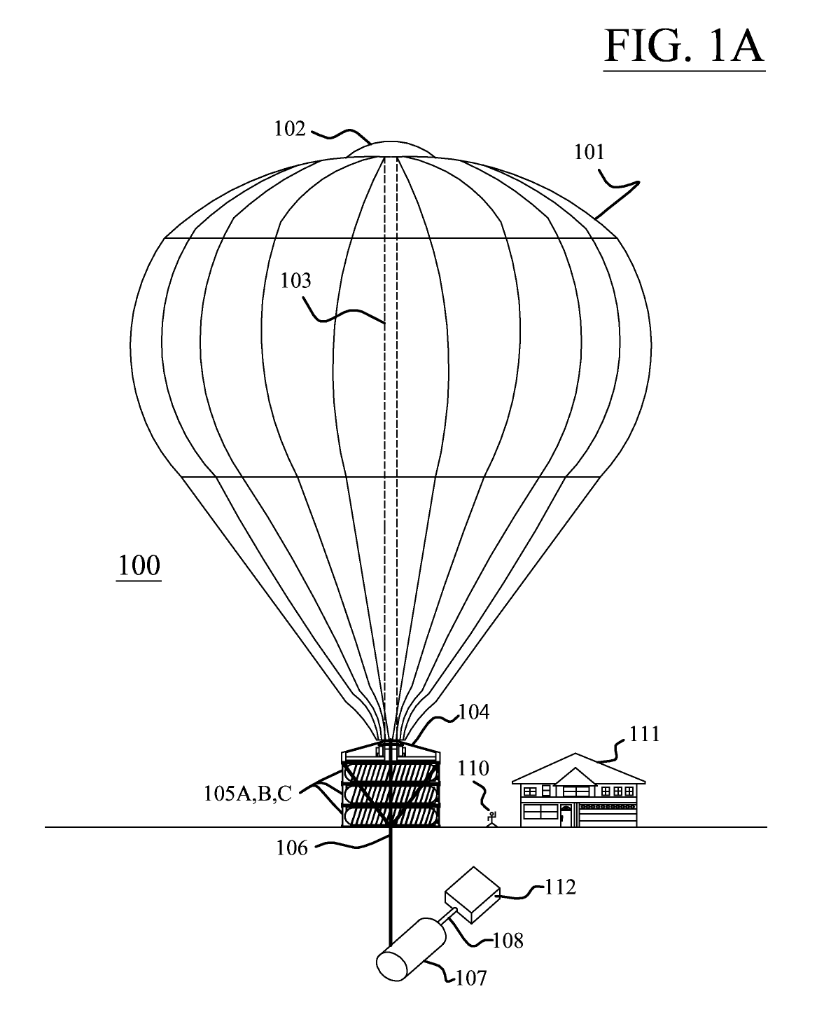

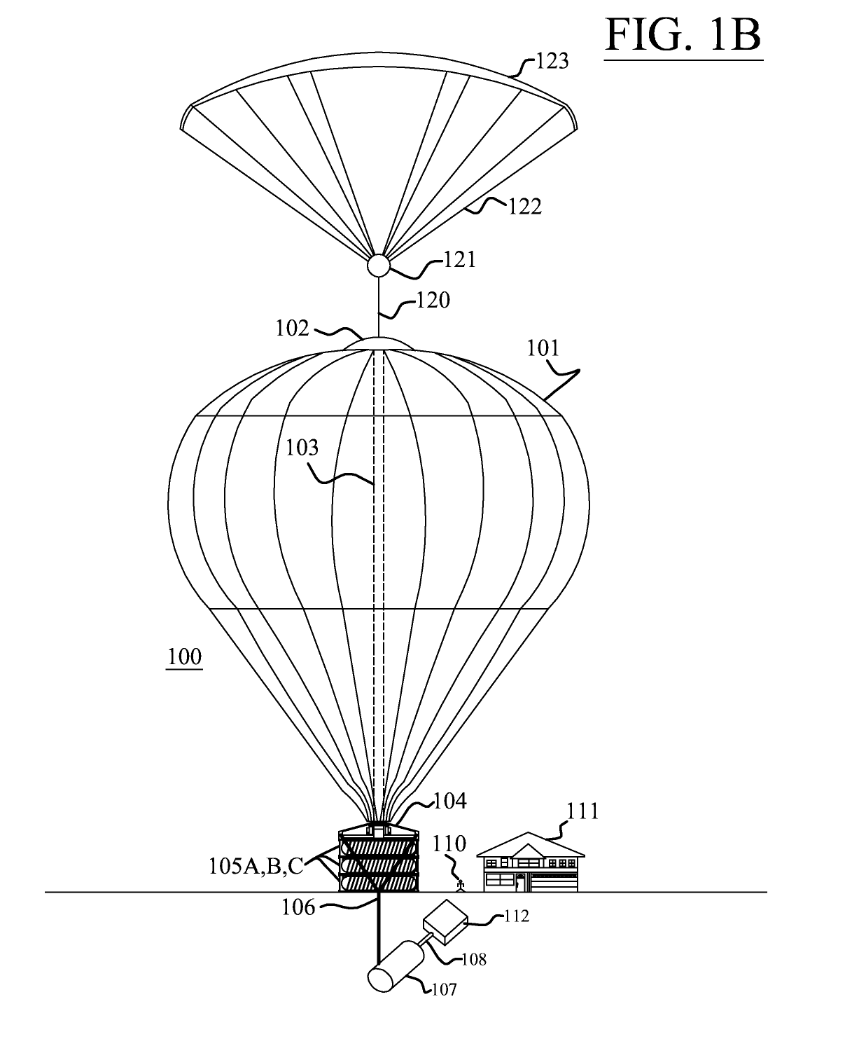

Now looking at FIG. 1A. 100 is a 200 feet diameter balloon system with three mobile thermal storage containers attached to it, reference numeral 101 refers to a lighter than air balloon, reference numeral 103 refers to the central telescopic shaft that can be increased or decreased in length by various means to change the volume of the balloon 101, on top of the shaft 103 is a hub 102 for balloon reinforcing and storage of various equipment (e.g., kites), 104 is the frame attached to the balloon and central shaft this frame may house pumps, electrical generators and other equipment and can attach to the first mobile thermal storage container 105A, which in turn can attach to 105B and 105C with quick connect/disconnect pins similar to shipping container connecting pins used to attach container handling equipment and one container to another, each additional container can be attach to the container above it with similar attachment pins as the first container. 106 is a tether fastened to a reel on the ground. A 6 feet tall man is shown at 110 next to a two-story house 111 to give an idea of the scale of the balloon and container combination.

Alternatively, as shown in FIG. 1A, the tether 106 can be wound around a reel 107 connecting to a shaft 108 of a generator 112 positioned on the ground. As the balloon systems 100 ascend, the tether wound around the reel 107 is pulled during the traction phase, causing the reel to turn. The turning of the reel 107 thus causes the generator shaft 108 attached to it, to turn while turning the generator 112. Turning motion of the generator extracting power (electrical current), from the energy of the balloon system 100. Similar methods for winding a tether for a kite-based wind power system are disclosed in US publication numbers 20090289148, 20090160426, 20090072092 and 20090033098, and issued U.S. Pat. Nos. 7,752,830, 7,656,053, and 7,516,605, the entire contents of all of which are incorporated herein by reference.

FIG. 1B is an identical lighter than air balloon system depicted in FIG. 1A, with the exception of a large kite 123 attached to the top of it by an attachment cable 120 and cable hub 121 and a series of cables 122 from cable hub 121 to the kite and 123. The kite 123 can add greatly to the lifting capacity of the balloon as well as the rate of ascent and the traction force exerted on the tether during the ascent phase of the flight. In this example, a balloon is shown with 3 containerized type thermal storage units 105A, 105B, 105C attached to it just under the lifting frame assembly equipment compartment. The items identified by reference numbers 107, 108 and 112 serve the same function in this arrangement as described above in description of FIG. 1A.

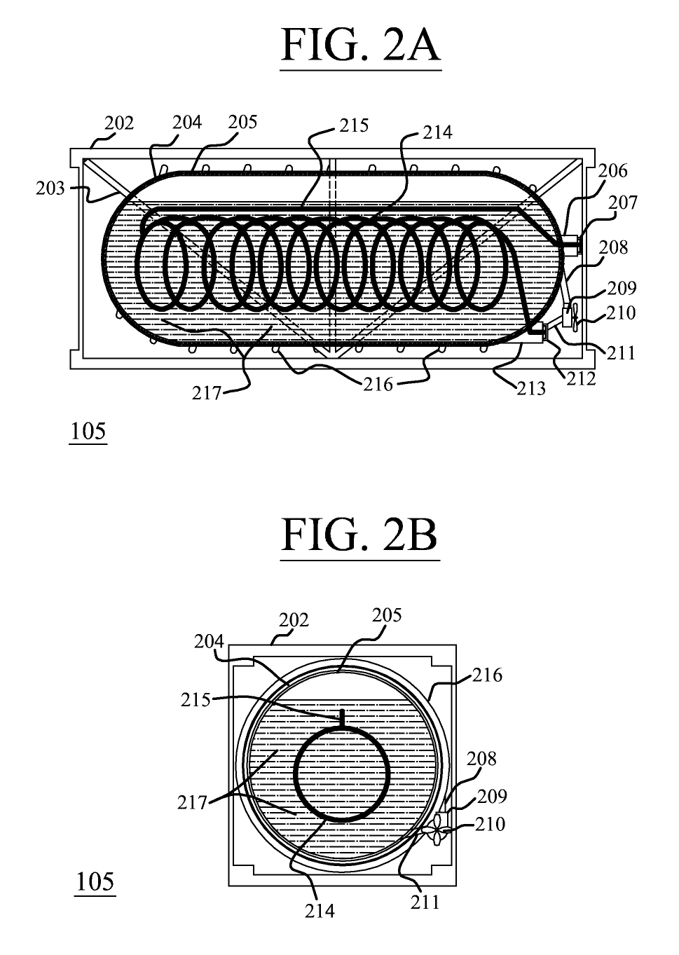

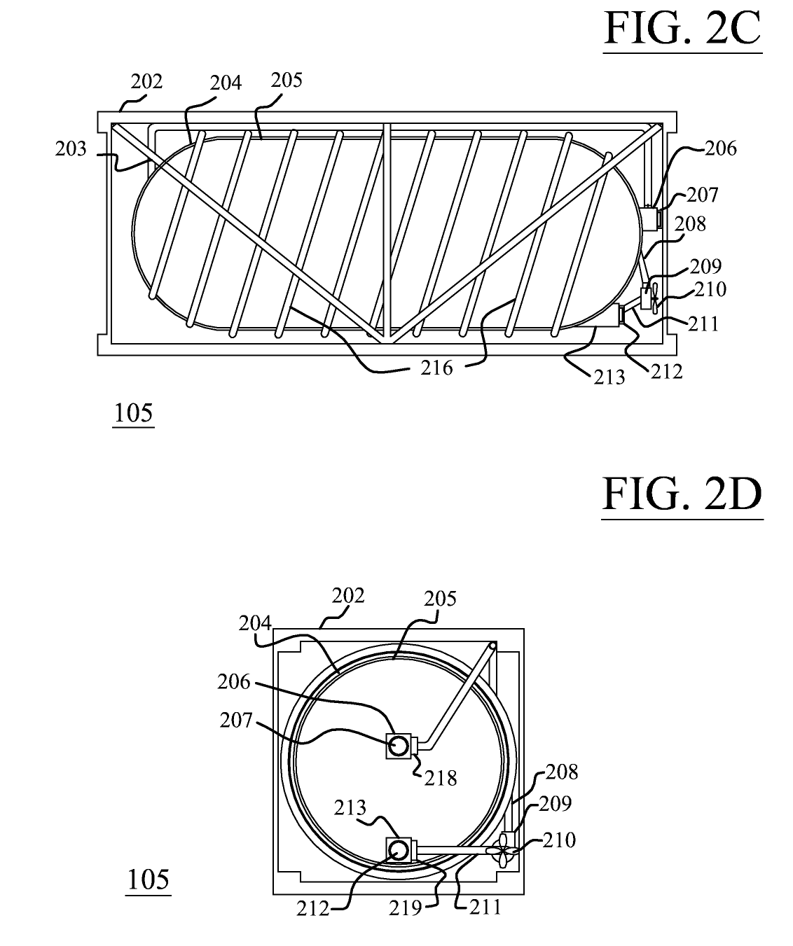

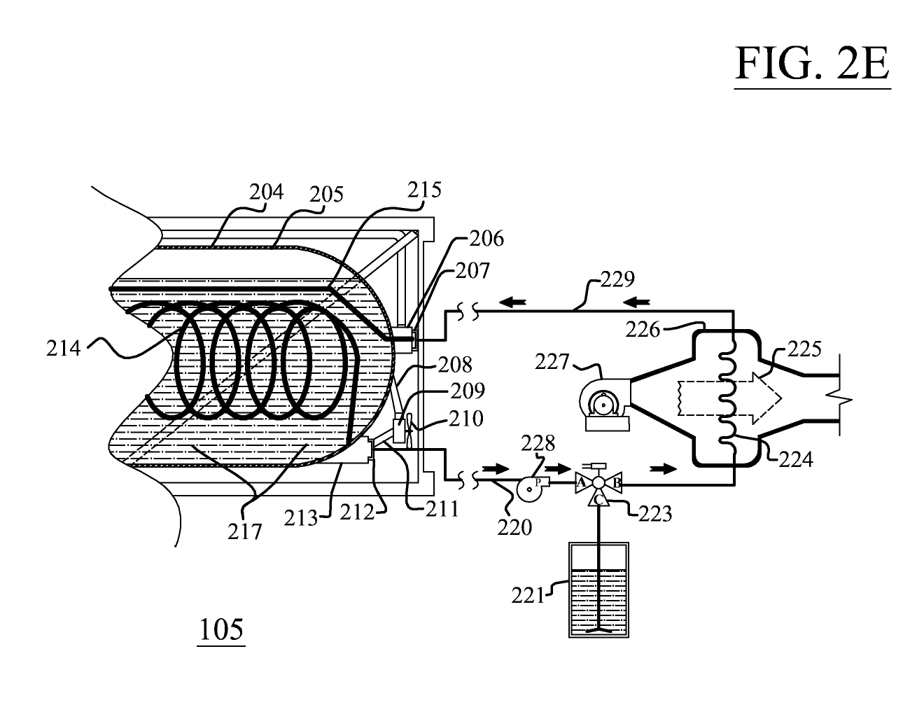

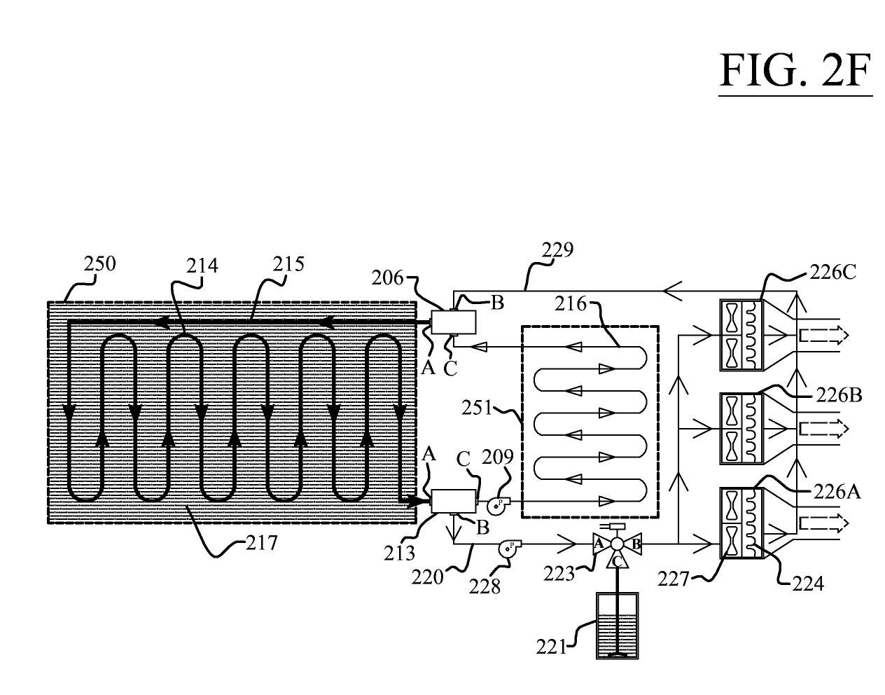

FIGS. 2A-2B illustrates a cutaway of side view and cross-sectional view of thermal storage unit 105 showing an example of a possible configuration of internal heat exchanger pipes. The thermal storage unit 105 may include a frame 202, which can include reinforcing cross bracing 203. The frame 202 supports a thermal storage medium tank having an outer wall 205, which can include a good light weight insulating material 204 such as Aerogel or similar insulation. A manifold 206 can include inlet outlet pressure relief valves, e.g., solenoid operated valves to which a supply line from external heat exchanger piping 216 can be attached on the outside of the wall 205 and a supply line 215 to a first end of the internal heat exchanger coil 214 can be attached on the inside. A coupling 207, such as a quick disconnect coupling can be used to hook up the container to building or customer return line. The interior of the tank can be filled with a good thermal storage medium 217. The thermal storage medium and heat transfer liquid may include additives to depress temperature of phase change (e.g., freezing or condensation) to increase the cooling capacity of the thermal storage medium 217 and to keep the thermal storage medium in a fluid state (liquid or gas) when it is at low temperature to facilitate circulation of the thermal storage medium and heat transfer fluid in the internal and external heat exchanger piping.

By way of example, and not by way of limitation, the thermal storage medium 217 may be a liquid, such as water, that is characterized by a good thermal storage capacity or a mixture of mostly water and some thermally conductive material say aluminum oxide or a mixture of water and thermally conductive material and an insulating material of say wood saw dust or an insulating material only. Alternatively other natural or engineered liquids may be used as the thermal storage medium 217 or a combination thereof, with or without freezing point depressing agents added to the water. A second end of the internal heat exchanger coil 214 can be coupled to a manifold 213, e.g., through an exhaust line. The manifold 213 can have an inlet and outlet valve port to which the exhaust line can be coupled and a quick disconnect coupling 212 that can be hooked up to a building or customer supply line to provide cooling liquid. A recirculation pump 209 can be coupled between the internal heat exchanger coil 214 and the external heat exchanger piping 216 via inlet manifold 206 and exhaust manifold 213, e.g., by an exhaust heat exchanger liquid line 208 from the pump 209 to exhaust manifold 206 on one side and to the pump via supply line 211 from the exhaust manifold 213. The recirculation pump can drive circulation of a heat exchange fluid through the internal and external heat exchangers. By way of example, and not by way of limitation, the recirculation pump 209 may be powered by a wind driven propeller 210 or ram air turbine (not shown) attached to re-circulation pump 209. Heat may be extracted from the heat transfer fluid inside the external heat exchanger piping 216 by suitable heat transfer thereby cooling the heat transfer fluid. Heat transfer may take place by radiation, conduction or convection (or some combination thereof) using standard techniques known to these skilled in the art. Heat may be extracted from the thermal storage medium by transfer of heat from the thermal storage medium 217 to the heat transfer fluid flowing in the internal heat exchanger coil 214. The extraction of heat may involve a change of phase (e.g., gas to liquid or liquid to solid), a decrease in temperature of the thermal storage medium or some combination of a phase change and decrease in temperature.

FIGS. 2C-2D is an illustration of exterior side and front views showing a complete mobile thermal storage unit 105.

FIG. 2E illustrates a thermal storage unit of the type depicted in FIGS. 2A-2D hooked up to a building heat exchanger unit 226 through building supply and return lines. A chilled heat transfer liquid (coolant) supply line 220 can be hooked up to a circulating pump 228 that is hooked up via supply line to a solenoid-operated 3-way valve 223 with port A of valve being an inlet and port B being an exhaust port connected to a line going to a building heat exchanger coil 224. A supply/reservoir and over flow tank 221 containing heat-transfer liquid can optionally be connect to port C of valve 223 to supply additional liquid from a reservoir or to store surplus heat exchanger liquid into the reservoir. A blower fan/motor combination 227 can be used to blow air within the heat exchanger coil 224 of unit 226 to force chilled air 225 throughout the building envelop via a forced air supply ducts system (not shown). A return line 229 carries heat-transfer fluid (coolant) away from heat exchanger unit 226 and back to thermal storage unit 105 to be circulated through the internal supply line 215 to internal heat exchanger 214 to be chilled and re-circulated once again to the building cooling or refrigeration system.

FIG. 2F schematically illustrates a cooling circuit of a mobile thermal storage container hooked up to a multi-zone building forced air cooling system. In this example, the chill heat transfer liquid supply line 220 can be hooked up to a circulating pump 228 that is hooked up via a supply line to a solenoid-operated 3-way valve 223 with port A of valve being the inlet port B exhaust port connected to line going to multiple building blower and heat exchanger units 226A, 226B and 226C. Each unit 226A, 226B, 226C may independently provide forced chilled air to a different zone of a building to provide multi-zone cooling.

A coolant supply/reservoir and or over flow tank 221 may be connect to port C of valve 223 to supply additional heat-transfer liquid from the reservoir or to store surplus heat transfer liquid (coolant) into the reservoir 221. Return line 229 carry heat-transfer fluid (coolant) away from heat exchanger and back to thermal storage unit 105 to be circulated through internal supply line 215 to internal heat exchanger unit 250 to be chilled by heat exchange between the cool thermal storage medium 217 and the coolant flowing through the internal heat exchanger coil 214. The charged coolant can be re-circulated once again to the building cooling or refrigeration system. It is noted that the complete external heat exchanger 251 can be disconnected and or isolated by closing port C of exhaust manifold 213 and port C of supply manifold 206 so that no coolant flows through the external heat exchanger unit 251 and its piping 216 during supply of coolant to customers on the ground. Whereas, while the heat exchanger unit is hooked up to the balloon system 101 per FIG. 1A and FIG. 1B and is aloft port B of supply manifold 206 and port B of exhaust manifold 213 can be closed and port A and B on supply and exhaust manifold can be open to allow for circulation of heat transfer fluid between internal and external heat exchanger units 250 and 251 respectively.

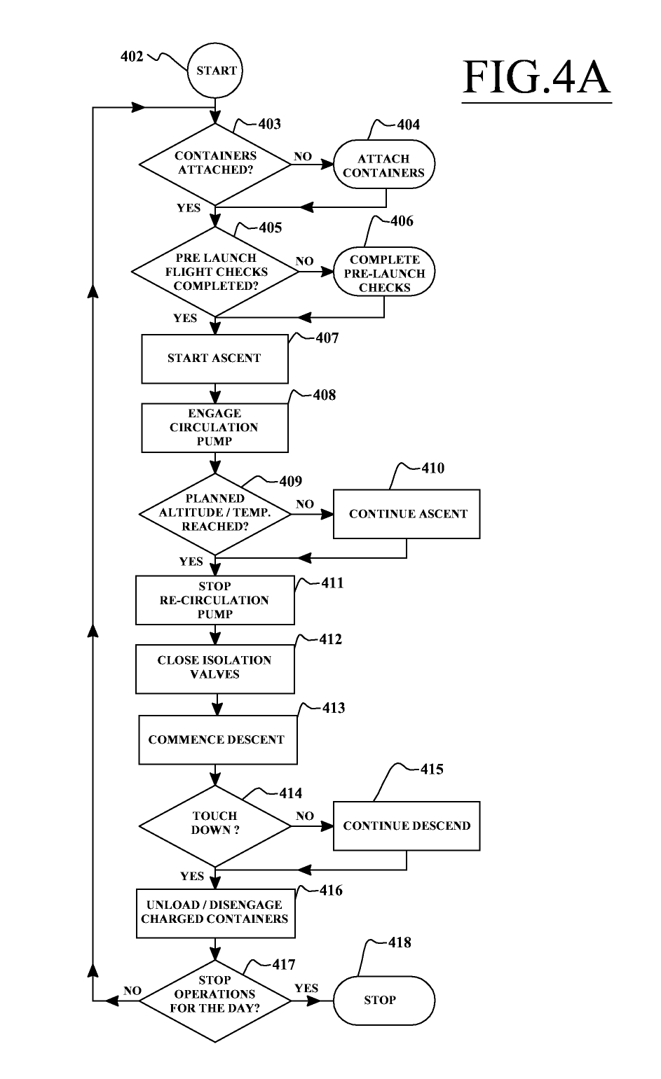

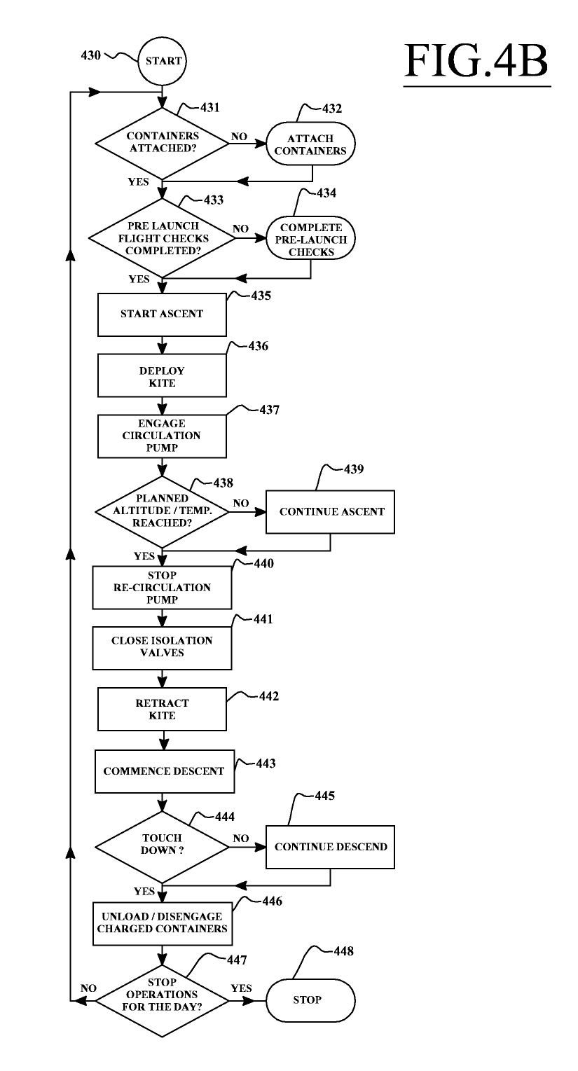

FIG. 4A is a flow chart depicting various steps in launching a lighter then air gas filled balloon with thermal storage containers attached to it for a trip to higher altitudes. At step 402 a signal is received from a controller indicating that the balloon is to be launched. The launch signal may be initiated, for example, by an operator pressing a launch button in the control room (e.g., mechanical button, or virtual buttons on a GUI interface, heads-up display, or via a voice command (e.g., voice recognition via digital signal processing (DSP) or other technologies). The launch signal may be transmitted partially or entirely via wireless devices (e.g., remote initiation via a wireless network communication (e.g., 802.11 signal, infrared signal, or a wireless communication available as an option on a remote launch keyfob (implemented, for example, as a separate button or specific pattern of other buttons already on the keyfob (e.g., press launch 4 times in rapid succession).

To ensure that launch sequence is not started unintentionally, a very unique pattern or launch code may be used to initiate launch. At the time launch sequence is initiated a proactive confirmation can be required to ensure that thermal storage containers are attached to the balloon and ready to go at step 403. If not, a warning signal or light can be activated informing the operator to attach discharged containers at 404. Pre-launch flight checks can be completed before balloon is released for launched at 405, if pre-launch checks are not completed the controller can prevent release of docking clamps until the checks are completed, as indicated at 406. At 407 after docking clamps are released the balloon can start its ascent. At 408, the circulation pump can be turned on by the controller based on altitude or temperature or some combination of temperature and altitude, preferably at about 100 meters above ground level (AGL). At 409 a decision can be made to determine if a planned altitude and or temperature has been reached. If not at 410 the ascent can continue. If so, then via a signal from the controller the circulation pump can be shut down, as indicated at 411. At 412 isolation valves can be closed cutting off the interior of thermal storage tank heat exchanger from the external heat exchanger to preserve the cold stored inside the tank. At 413, descent is commenced e.g., via a signal from the controller to evacuate lighter then air gas from the envelop of the balloon by either compressing the lighter-than-air gas into compressed gas tanks or via a gas supply line attached to the tether (not shown), thereby, making the balloon less buoyant and putting it into a controlled descent. Alternatively, ambient air may be ingested into special bladder in the envelope of the balloon, thus making the balloon heavier and less buoyant, essentially, putting it into a controlled descent. As alternative to the above two scenarios, both of the above can be done to put the balloon into a controlled descend. Or the tether simply can be rewound to pull the balloon back to the ground. At 414 a decision can be made to determine if the balloon has touched down onto the ground. If not at 415, the balloon can be instructed to continue its descent. Once safely on the ground and locked into position, fully charged containers can be disengaged from the balloon at 416. At 417 a decision can be made whether to stop operation for the day or to continue. If the answer is to stop than at 418 the operation may be terminated for the day; if the answer is NO than new discharged containers are hooked up and the whole process may be repeated starting back at 403.

FIG. 4B is a flow chart depicting various steps in launching a lighter-than-air gas-filled balloon and an over sized kite attached to it to enhance lifting capacity as well as to increase the rate of ascent of the balloon/kite combo, with thermal storage containers attached to it for a trip to higher altitudes. At step 430 a signal is received from the controller that the balloon is to be launched. The launch signal can be initiated, for example, by an operator pressing a wash button in a control room (e.g., mechanical button, or virtual buttons on a GUI interface, heads-up display, or via a voice command (e.g., voice recognition via digital signal processing (DSP) or other technologies). The launch signal may be transmitted partially or entirely via wireless devices (e.g., remote initiation via a wireless network communication (e.g., 802.11 signal, infrared signal, or a wireless communication available as an option on a remote launch keyfob (implemented, for example, as a separate button or specific pattern of other buttons already on the keyfob (e.g., press launch 4 times in rapid succession).

To ensure that launch sequence is not started unintentionally, a very unique pattern or launch codes may be used to initiate launch. At the time launch sequence is initiated a proactive confirmation may be required to ensure thermal storage containers are attached and ready to go at step 431. If not a warning signal or light can be activated informing the operator to attach discharged containers at 432. Pre-launch flight checks can be completed before balloon is released for launched at 433, if pre-launch checks are not completed the controller will not release docking clamps until check are completed at 434. At 435 after docking clamps are released the balloon can start its ascent. At 436, signal from the controller deploys an over sized kite to provide additional lifting force thereby, increasing the rate of climb. At 437, circulation pump may be turned on by the controller based on altitude or temperature, or temperature/altitude combination, preferably at 100 meters above ground level (AGL). At 438 a decision is made to determine if planned altitude and or temperature is reached, if not at 439 the ascent is continued, if yes then via a signal from the controller circulation pump is shut down at 440. At 441 isolation valves are closed cutting off the interior of the thermal storage tank heat exchanger from the external heat exchanger to preserve the cold stored inside the tank. At 442 over sized kite can be partially or completely retracted or even reduced in size by folding certain sections of the kite, as a result of a signal from the controller in preparation for a descent, or at a later predetermined altitude upon reaching that altitude rate of descent or combination of the two. At 443, descent is commenced via a signal from the controller to evacuate lighter then air gas from the envelop of the balloon by either compressing the lighter than air gas into compressed gas tanks or via a gas supply line attached to the tether (not shown), thereby, making the balloon less buoyant and putting it into a controlled descent. Alternatively, ambient air may be ingested into special bladder inside the envelope of the balloon thus making the balloon heavier and less buoyant, thereby, putting it into a controlled descent. Alternative to the above two scenarios both of the above can be done to put the balloon into a controlled descend. Or the tether simply can be rewound to pull the balloon back to the ground. At 444 a decision is made as to if the balloon has touched down onto the ground, if not at 445, balloon is instructed to continue its descent. Once safely on the ground and locked into position, fully charged containers are unloaded at 446. At 447 a decision is made whether to stop operation for the day or to continue, if the answer is stop then at 448 the operation may be terminated for the day, if the answer is NO then new discharged containers can be attached and the whole process may be repeated starting back at 431.

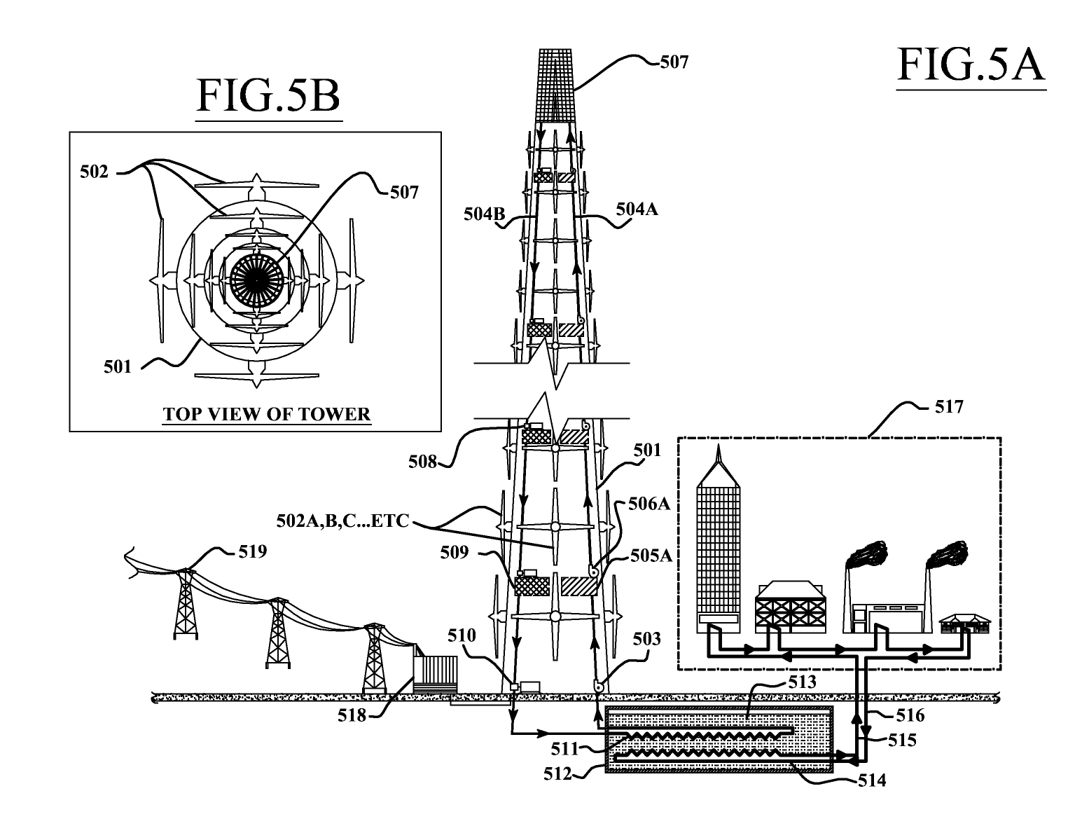

The present invention is not limited to embodiments that use balloons, balloon plus kite combinations, kites, gliders or aircraft. For example, FIG. 5A-5B, illustrate an example in which a purpose built ultra tall tower or a building 501 includes a series of wind power turbines 502s located along the vertical and horizontal surface of the tower. The size of the propeller and turbines can be reduced with increased distance from the ground to compensate for smaller mounting surface area and higher wind speeds at higher altitudes of the tower. At least one, but preferably more, of the wind powered turbines 502 can be used to drive a pump instead of an electric generator (not shown) to pump heat transfer fluid through the liquid transmission line 504A, running from ground level to the top of the tower. 503 is the main heat transfer fluid pump located on the ground to pump heat transfer fluid to be cooled through ascending liquid supply line 504A, to the first temporary liquid storage tank 505A located a few hundred feet above, a liquid pump 506A located on or inside 505 can than pump the liquid in 505 up through liquid transmission line 504A to the next temporary storage tank 505B where the next liquid pump 506B can pump the liquid to the tank 505C above it and so on until the liquid reaches the top of the tower. A series of temporary liquid storage tanks 505 and pumps 506 can be utilized to reduce the distance the liquid has to be pumped thereby, reducing the pressure head and pumping load starting on main pump 503 and all subsequent pumps 506 in a stepped fashion. The liquid transmission line 504A and all temporary liquid storage tanks 505s are of an un-insulated type to ensure heat dissipation of ascending heat transfer liquid takes place into the surrounding atmosphere as it is being pumped through the line 504A. Finally at the top of the tower the heat transfer fluid coming up through the line 504A can flow through a massive heat exchanger unit 507, at the very top of the tower/building where it is further cooled as a result of exposure to the cold atmospheric temperature at the top of the tower/building. Once the liquid reaches temperature of the outside atmosphere it is allowed to flow through control valves (not shown) into descending liquid return line 504B. 504B being of a heavily insulated type to ensure cold temperatures of the liquid are preserved as higher atmospheric temperatures are encountered at lower altitudes. To reduce the pressure head in the descending line and to harness the kinetic energy of the falling liquid in line 504B the liquid can flow through a turbine wheel coupled to a an electrical generator or a power extractor 508. Upon passing through 508 the liquid can enter a heavily insulated temporary storage tank 509 similar in purpose to storage tanks 505 but in reverse order and on the downward leg. The stored potential energy of the liquid in 509 can be released through line 504B below it until the liquid reaches the next turbine wheel and generator and into a temporary tank below it and so on in a stepped fashion. The diameter of the lines 504A and 504B may decrease as the altitude increases on the ascending side and increase on the descending side as the altitude decreased. Similarly the size of temporary liquid storage tanks 505 and 509 can decrease in capacity as the altitude increases. There can also be a large holding tank of liquid at the very top of the tower (not shown) to ensure the system is always primed and plenty of residual liquid is always present at the top to supply the descending line 504B to compensate for drop in pressure or rate of flow of liquid coming up through 504A from the ground. Upon reaching the ground level the liquid can flow through the biggest of the turbine wheel and generators combination unit 510 located on the ground level to extract maximum kinetic energy out of the falling liquid, which can then enter an under ground line and into a heat exchanger unit 511 located inside of a thermal storage unit 512 filled with a good thermal storage medium 513, as the heat transfer liquid returning from higher altitudes circulates through 511 it can absorb the heat from 513 thereby making 513 cold or super cold. Upon absorbing sufficient heat from 513 the liquid can exit the heat exchanger unit and be pumped by pump 503 through line 504A for another trip to the top of the tower to be cooled once again. The cycle may be repeated on a continuous basis 24 hours a day, 7 days a week. To supply cooling to end users, a second heat exchanger unit 514 can be submerged in 513 inside 512. Heat transfer fluid can be supplied to customer via supply line 515 to a wide variety of industrial, commercial and residential end users as depicted in 517. Heat transfer fluid can be returned back to the heat exchanger 514 by a return line 516 to be charged before it is circulated back to the end users. Alternatively in another embodiment the internal cooling supply heat exchanger 514 can be eliminated and thermal storage medium 513 can be circulated directly to end users via customer supply line 515. Thermal storage medium 513 can be kept in a liquid (or gas) state with the help of freezing point depression additives or boiling point depression additives mixed into the thermal storage medium (e.g., water) to ensure it has a higher thermal storage capacity and is easily distributed to customers via liquid supply lines. An electrical sub-station 518 can collect the electrical power generated by a series of 502s and 508s for onward distribution via transmission lines 519 to local or national electrical grid. In another embodiment parts of the ultra tall tower/building or entire exterior surface may have solar panels (photovoltaic cells, not shown) especially on areas experiencing direct sunlight to increase production of electricity.

In an other embodiment in addition to the having liquid transmission line going up and back down the tower to transfer high altitude cooling to the ground, air duct can be run up and down the tower to move air from the ground to the top of the tower and then the chilled air moved back to the ground for direct cooling or for cooling of thermal storage unit by the returning chilled or super chilled air.

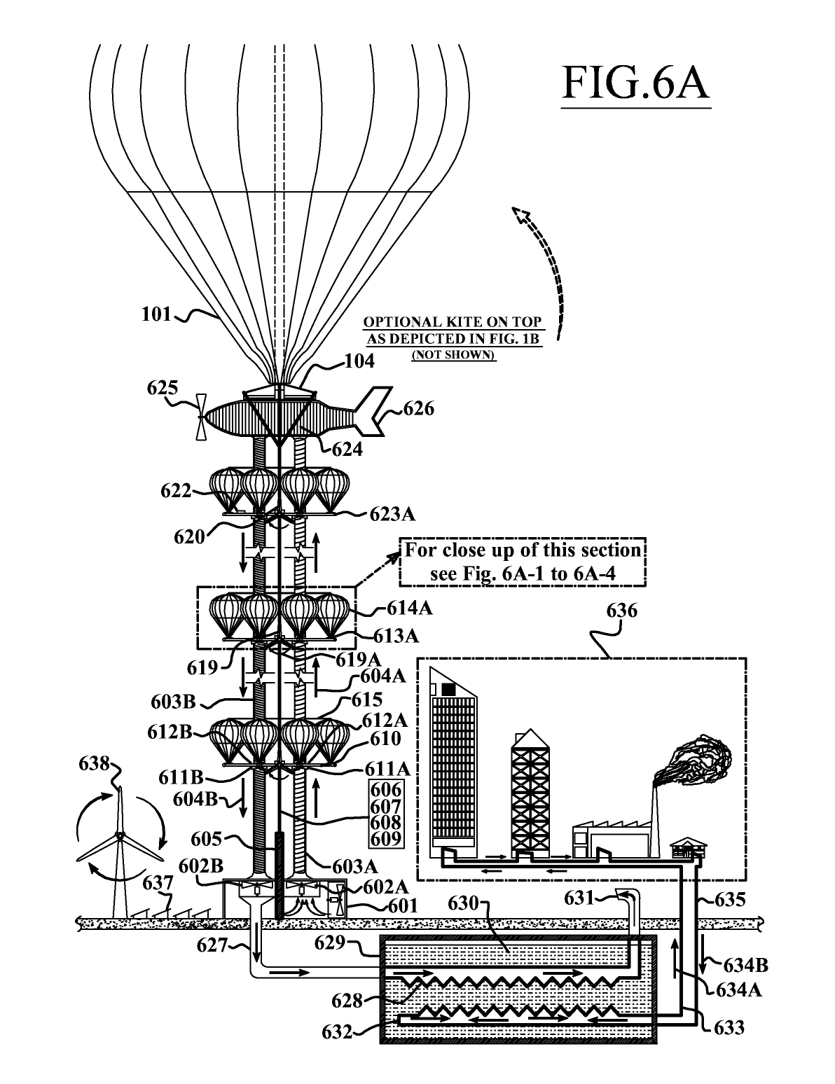

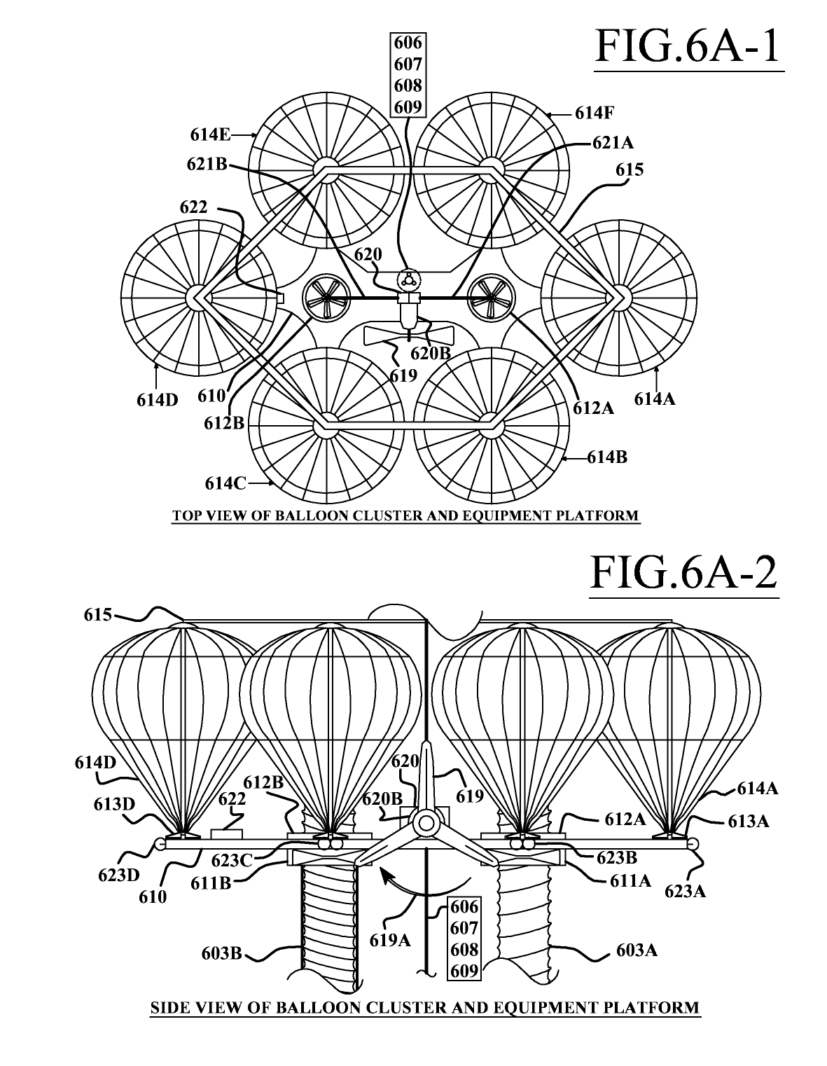

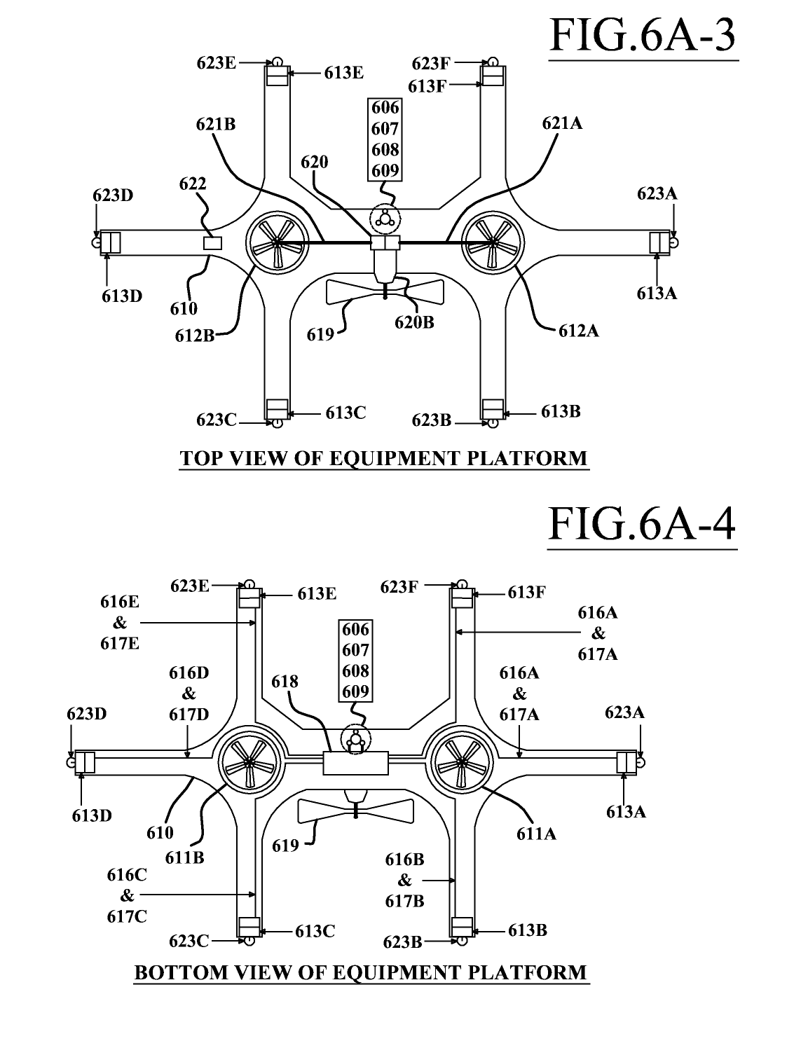

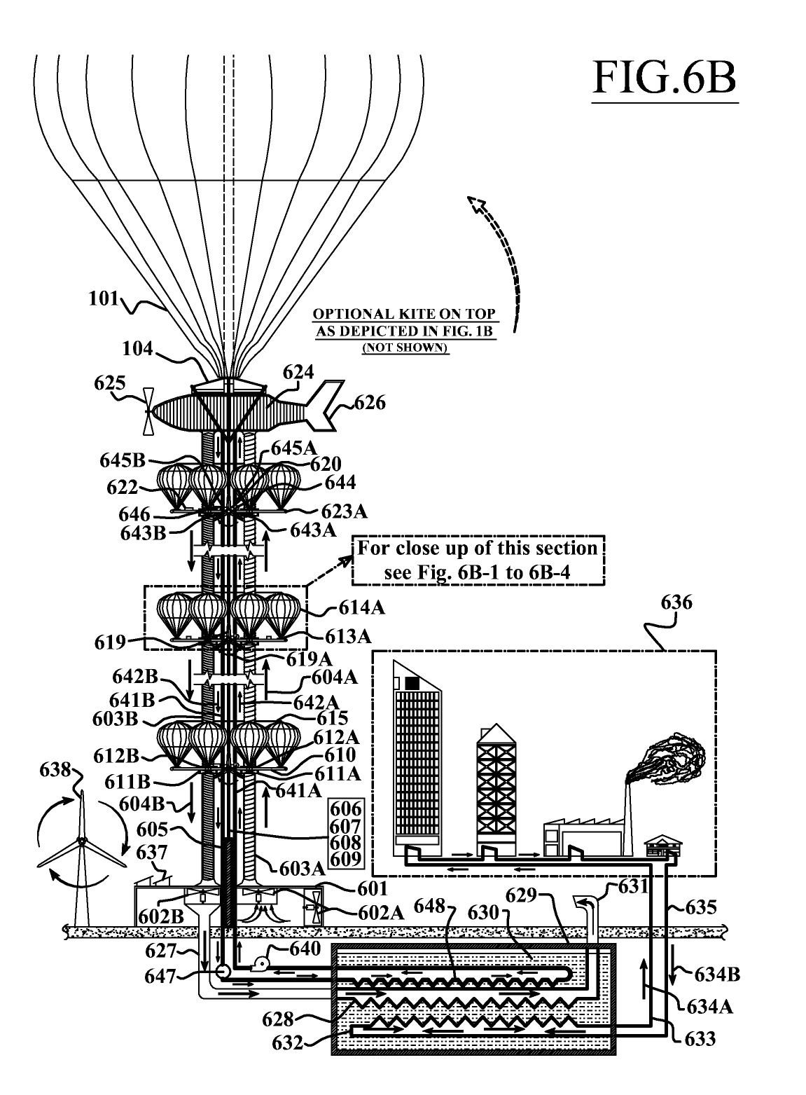

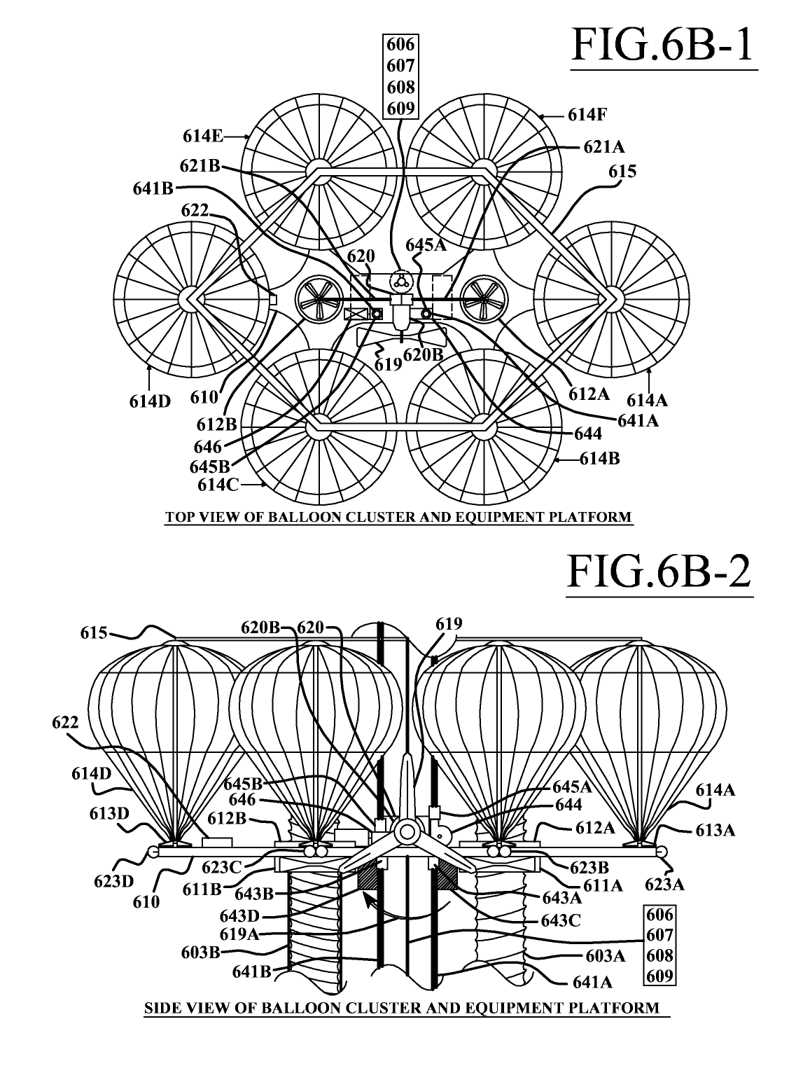

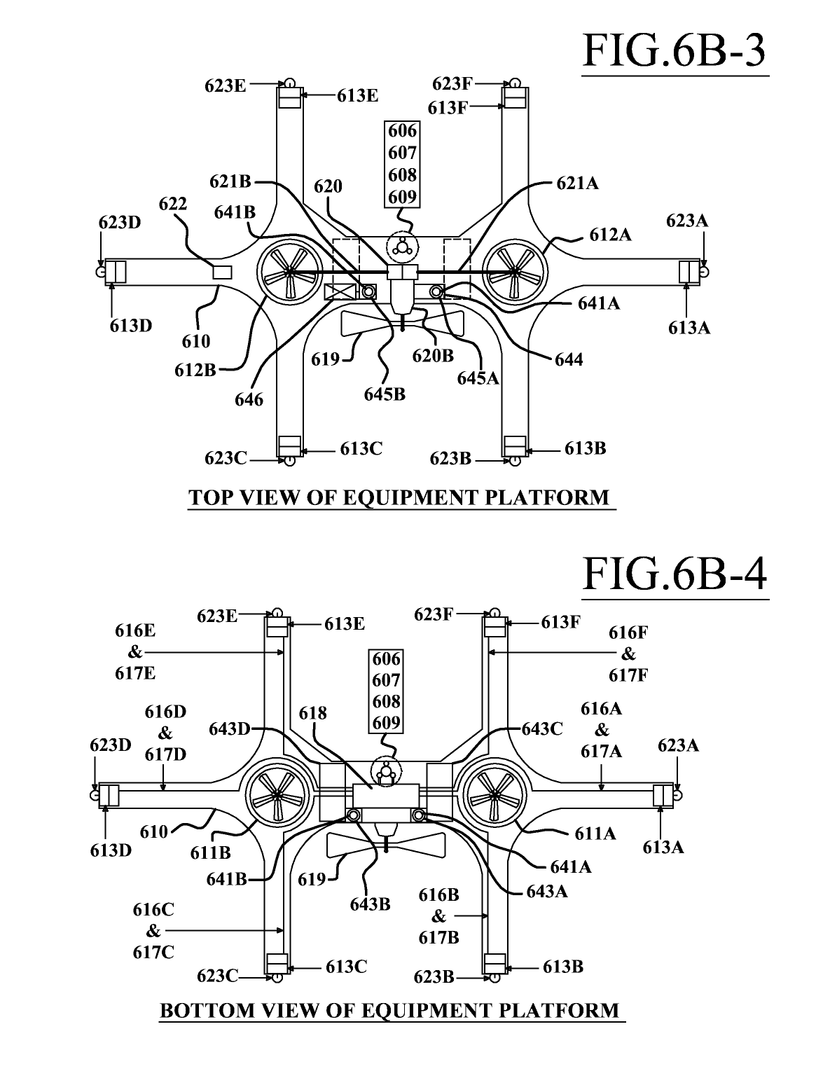

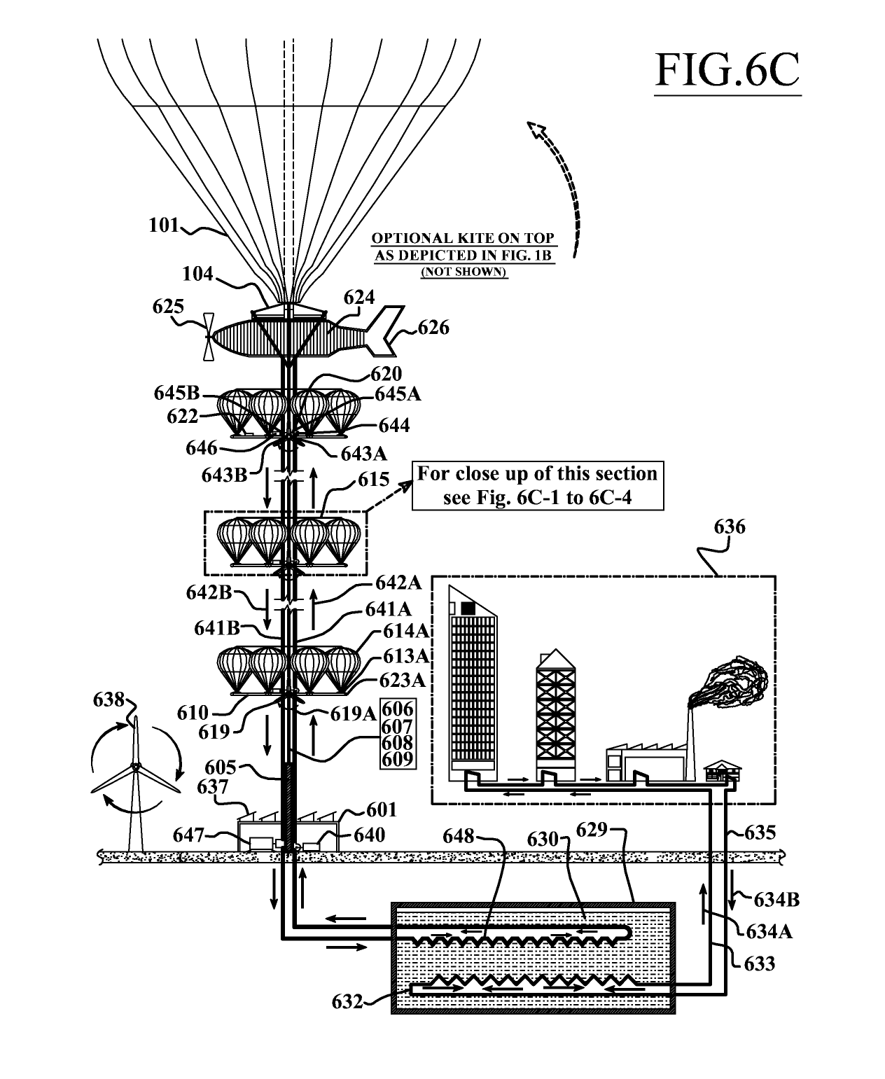

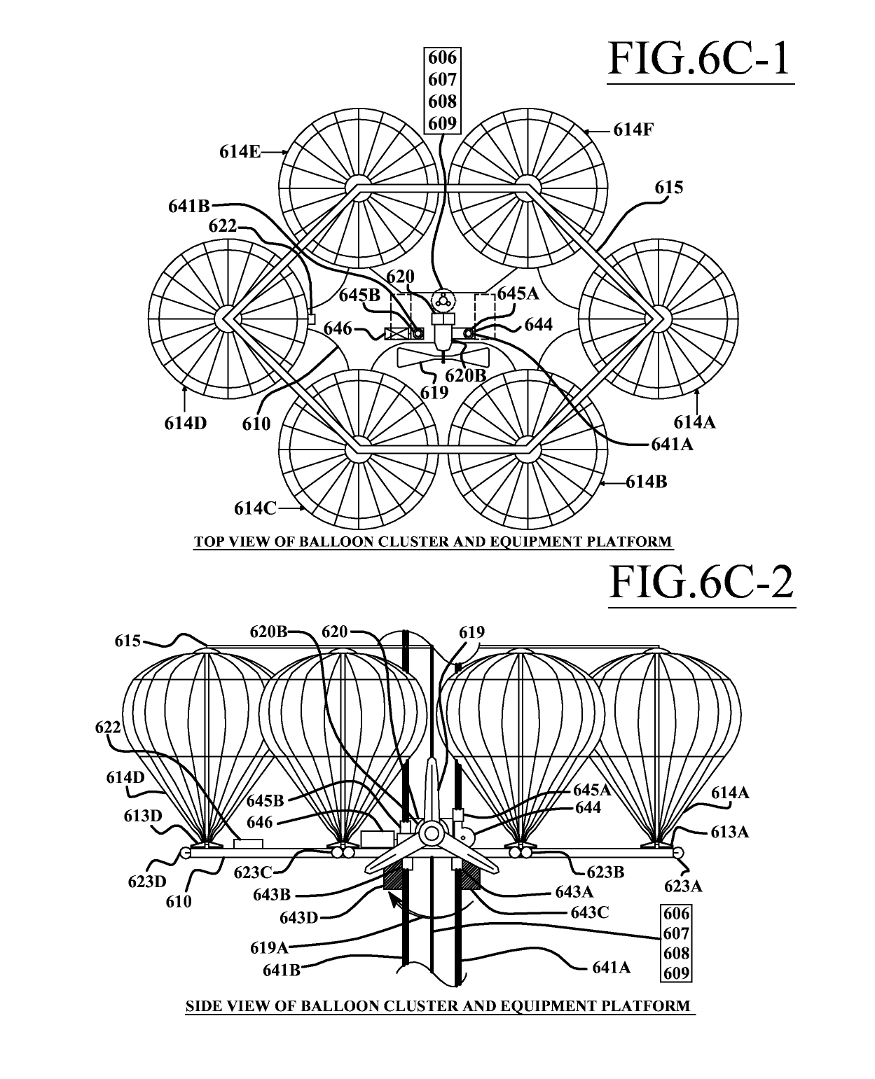

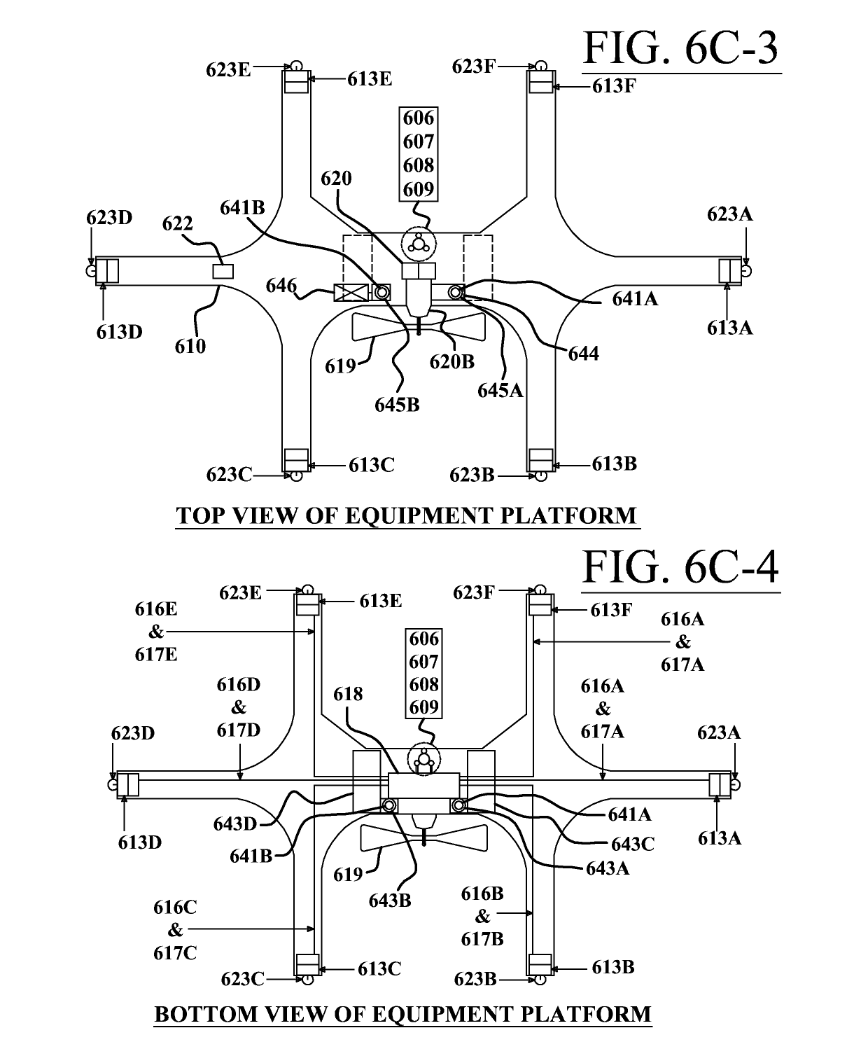

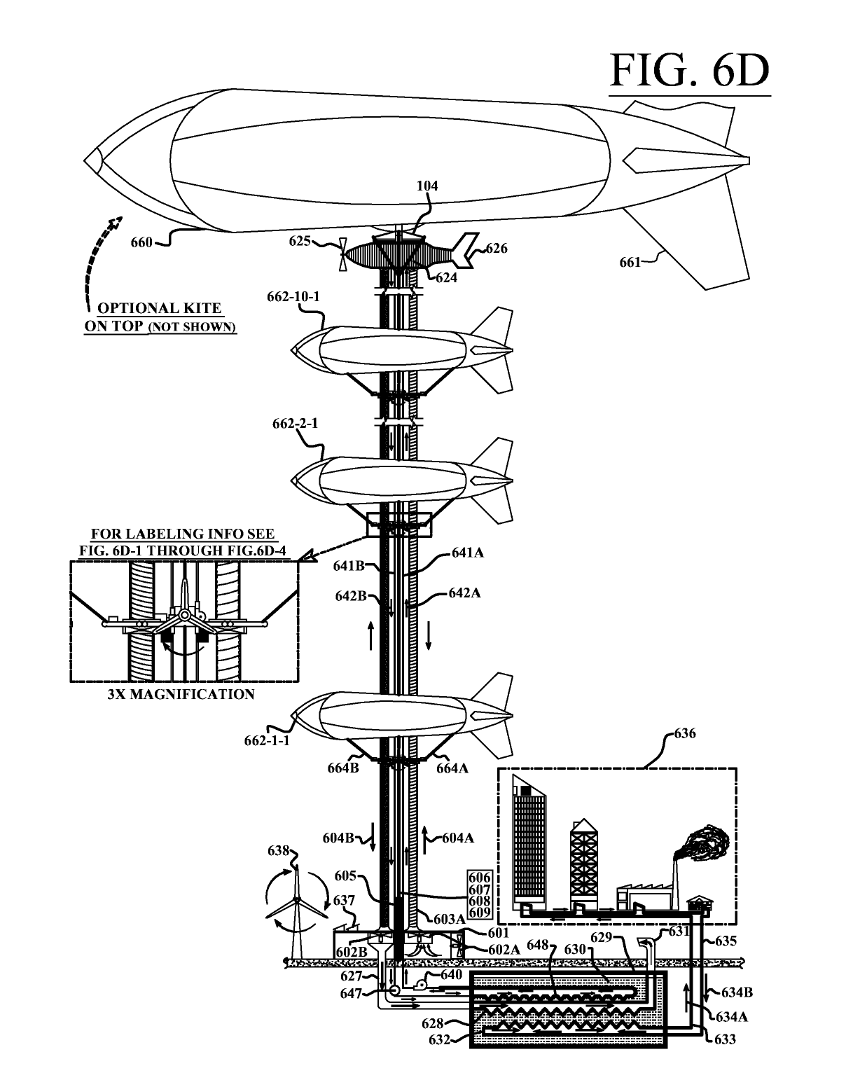

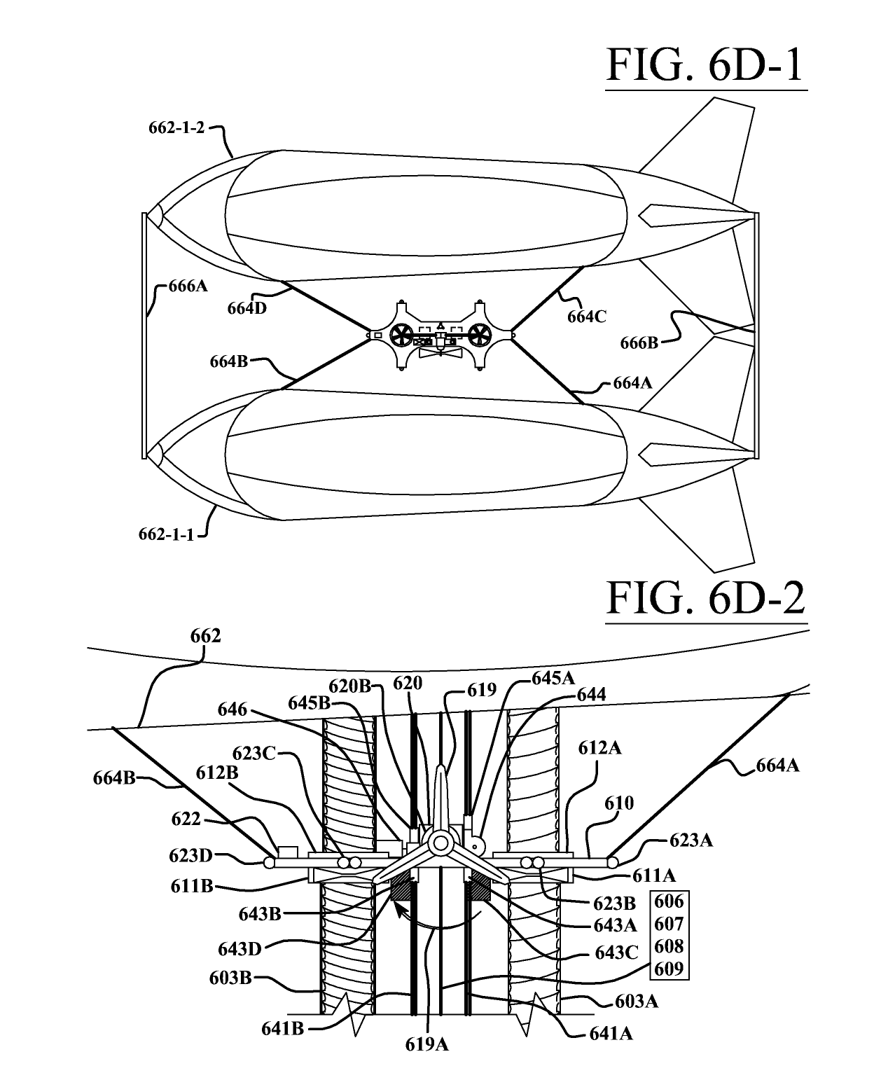

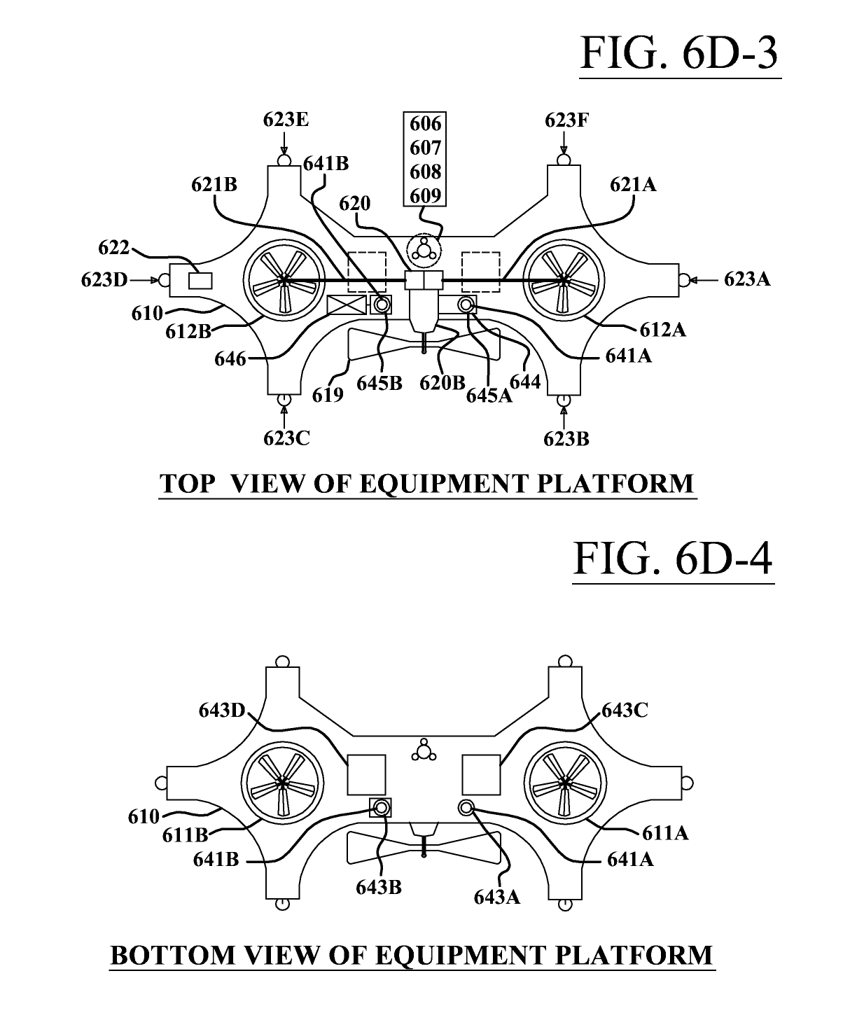

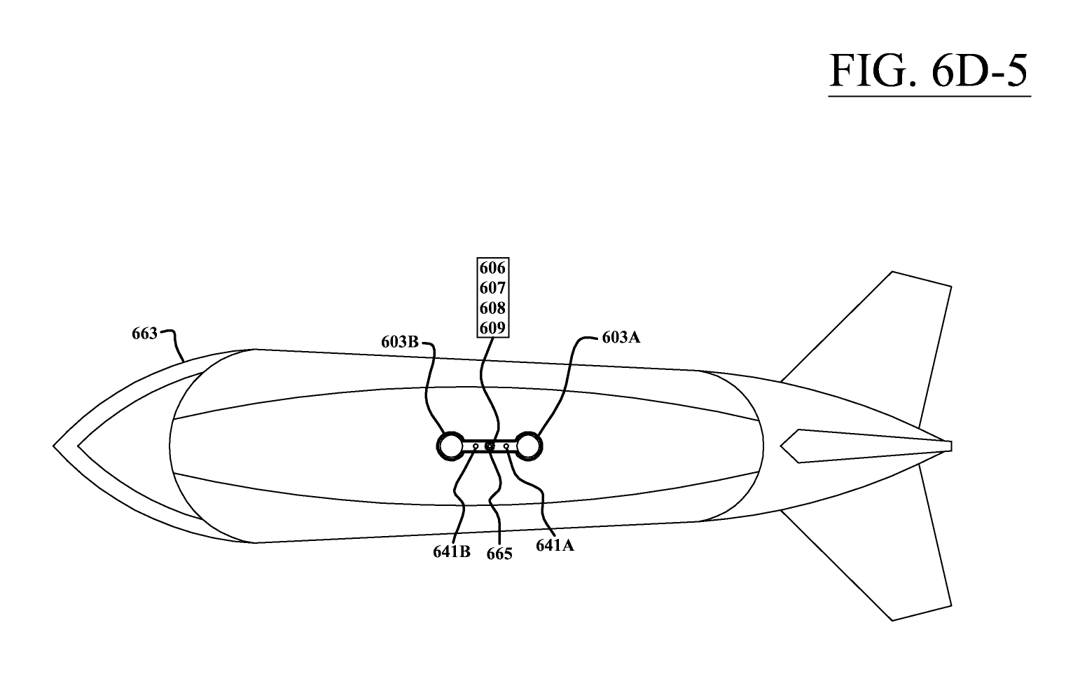

FIG. 6A shows a complete system to lift air circulation supply and return ducts from the ground level to desired altitude and back down again by a lighter than air gas filled or hot air balloon or a combination of balloon and kite or a kite alone. In addition to one large main large balloon, at least one smaller or a series of smaller lighter than air gas or hot air filled balloons can be attached in clusters to an equipment platform. A section of duct can be attached at a bottom of the platform and a second section can be attached to the top of the platform to form a single link. Several such platforms and ducts can be attached to each other to form a long chain stretching from the ground to higher altitudes. The balloons attached to the platforms can help carry at least some if not all of the weight of each link in the chain thereby, either completely or partially alleviating the load from the main balloon, essentially making each section a self lifting section. In addition to the balloon or cluster of balloons a combination of balloon and kite arrangement may be used, or alternatively a single large balloon with a pass through opening for the passage of ducts, tether, electrical cable, gas supply and return lines going through that pass through opening in the balloon. This can effectively lighten the lifting load from the main balloon as each section of duct and its associated equipment can have a self lifting smaller balloon to carry the weight of each section. The air from the ground is blown through the duct by at least one powerful fan but preferably a series of blower fans directing air to the opening of the supply air duct located in an equipment room. The supply air duct can be un-insulated for the simple reason that as the air travels through the duct to higher and higher altitudes it gradually cools as a result of exposure of the duct to outside atmosphere, since the duct is not insulated the heat from the air inside the duct can dissipate more easily to the cooler outside atmosphere. At the top the air can be sent through a heat exchanger (if needed) attached to the main balloon where it can be further cooled and then blown back to the ground by at least one powerful blower fan or preferably a plurality of blower fans. It is important to point out that the duct on the down ward leg must be an insulated duct to keep the chilled air from heating up as it encounters warmer and warmer temperature due to lapse rate warming at lower altitudes Once the super chilled air is on the ground it can be sent through a heat exchanger located inside a thermal storage unit to chill or freeze a thermal storage medium such as water or any other good thermal storage medium whether natural or engineered liquid or a combination of the two. A good heat transfer fluid can then be circulated in another heat exchanger unit located inside the thermal storage unit and then circulated via piping to customer to be used for cooling purposes. Alternatively chilled air may be circulated to end users directly instead of charging the thermal storage unit which in turn can supply cooling to end users.

Referring again to FIG. 6A, one or more blower fans 602A, can be mounted inside the supply air compartment of equipment room 601. The series of blower fans 602As, can be used to draw in outside air and to blow that air up from the ground to higher altitudes through air supply duct 603A, 603A being an un-insulated duct to allow the air to cool as it rises through it due to atmospheric lapse rate drop in temperature. Upward direction of air travel is indicated by arrow 604A. 605 is an anchor unit to which the balloon tether 606 as well as electrical cable 607, gas supply line 608 and gas return line 609 are attached via a reel mechanism/electrical generator combination or power extractor unit (not shown). 610 is a lightweight aerial equipment platform to carry several different kinds of equipment (to be discussed later) as well as being the link between joining top and bottom duct, wires and hoses. At bottom of the equipment platform is an air duct quick connect/disconnect coupling 611A having a venturi type of interior with a built in booster blower fan to help blow air coming up through lower section of supply duct 603A through the coupling into the next section of duct above the equipment platform 610 the next duct section on top of the equipment platform can be attached to the top of the equipment platform via a quick connect/disconnect coupling 612A. A series of attachment clamps 613A, 613B . . . 613F are attached to the platform 610 for attachment of individual balloons 614A-614F.

As seen in FIG. 6A-1 through FIG. 6A-4 the balloons can be connected to a top brace 615 to keep the individual balloons 614A, 614B . . . 614F bound together at the top for stability. By way of example, attachment clamp 613A has a supply gas line 616A and a return gas line 617A attached to it to supply lighter than air gas or hot air to balloon 614A to inflate or deflate the same to control its buoyancy. The other attachment clamps 613B-613F similarly have corresponding supply gas lines 616B-616F and return gas lines 617B-617F for inflating or deflating corresponding balloons 614B through 614F. Each gas supply line and return gas line can be connected at the other end to a gas distribution manifold 618 through corresponding solenoid operated or pressure valves. Main gas supply line 608 and return line 609 can be attached via “T” fitting to gas distribution manifold 618 to supply and take away buoyancy gas from the balloon. “T” fitting at one end are attached to supply line 608 and return line 609 from lower section, at the 2^{nd} end they are attached to the gas distribution manifold 618 located on 610 and are attached to the next higher section of supply line 608 and return line 609 at the 3^{rd} end or top end connection may be via quick connect/disconnect couplings. Power to drive the booster fans located inside quick connect/disconnect air duct coupling 611A and 611B may be supplied by a fully or partially featherable constant speed windmill type propeller 619 fan located on 610 which in turn is attached to a gear box 620 at either side of the gear box 620 and at right angle, drive shafts 621A and 621B are arranged at one end connected to gearing in the gear box 620 and at the other end to gearing that is attached to a booster fan inside the housing of lower air duct quick connect/disconnect coupling 611A and 611B, 611A being the ascending side coupling and 611B the descending side coupling. In some embodiments, a generator 620B may be coupled to the propeller 619 (or gearbox 620) to generate electricity from the turning of the propeller 619. Reference numeral 619A indicates direction of rotation of wind mill propeller 619. Alternatively pulleys and drive belts may be used in place of drive shafts 621A and 621B, to power booster fans. The tuning force for the booster fans could be provided by electrical or hydraulic motors instead of wind power to power the booster fans in 611A and 611B. An appropriate size and weight power extractor, an electrical generator or dynamo type of electrical current producing device 620B attached to the shaft of 619 windmill propeller to convert turning mechanical force into electrical energy to be supplied where electrical current is needed on each equipment platform 610, it must be pointed out that a plurality of wind mill type propellers could be used on each equipment platform 610 to supply mechanical or electrical power as needed on each equipment platform or to supply power to the ground. Electrical power may be used by various aviation warning and communication equipment located inside of an aviation equipment box 622 as well as high visibility anti collision strobes and red and green navigation safety lights mounted in a cluster 623A . . . F at the end of each arm of 610.

Alternatively a small rechargeable battery pack (not shown) could also be provided to power the electrical systems and charged by the generator driven by the windmill propeller 619 located on the platform 610 or in another embodiment power may be provide from the ground via electrical cable 607. During initial deployment as each new section of air supply and return duct and equipment platform is added below the previous section the chain becomes longer and longer ultimately resulting in higher and higher altitudes being reached. A continuous tether 606, electrical cable 607, gas supply line 608 and gas evacuation line 609 could be used where each equipment platform 610 could be attached to the tether 606, electrical cable 607, supply line 608 and return line 608 via special hooks while passing through pass through opening in the equipment platform 610. Alternatively smaller lengths of tether 606, electrical cable 607, supply line 608 and return line 609, could be used having same size as air supply & return ducts 603A and 603B. Each length could then be attached to the equipment platform via hooks and or quick connect/disconnect couplings (not shown) at the top and bottom of each equipment platform to make longer lengths. All the sections could be attached to each other and laid on the ground, once ready for launch the controller could inflate the main balloon 101 first as it rises the smaller balloons 614A, 614B, 614C . . . 614F mounted to the first equipment platform 610 could be inflated simultaneously, thereafter as the first platform 610 rises the balloons of the other platforms 610 below the first one may be inflated so that the other platforms can ascend one at a time in a stepped fashion to make the entire duct system fully deploy to reach its desired altitude.

Alternatively, in place of pre-attaching the entire length of duct on the ground, each section could be attached one by one as the sections above it rise higher and higher. As noted above, the main balloon 101 can have a container attachment frame 104, which can be attached to its bottom. The container attachment frame 104 can be designed to attached to an over sized heat exchanger unit 624 via quick connect/disconnect pins similar to shipping container attachment pins (not shown) used by shipping cranes on docks and container handling vehicles, thereby, facilitating a quick connection and disconnection of heat exchanger unit 624 from the attachment frame 104 and main balloon 101. A featherable constant speed windmill type propeller 625 can be attached at one end of heat exchanger unit 624 to supply power via drive shafts, gearing or belts and pulleys to blower fans (not shown) located inside heat exchanger unit 624. At the opposite side of the heat exchanger unit 624 is a weathervane-type fin 626 to stabilize 624 and to keep it pointed into the wind. As the air from supply duct 603A comes up and enters the heat exchanger 624 through an entry port (not shown) its velocity and volume is increased by circulation fans located inside 624 that are driven by windmill propeller 625. A blower fan located in an inlet port of the heat exchanger 624 where 603A supply air duct is attached and can be arranged to turn so that it sucks air from the duct 603A and into the heat exchanger 624. The air can be circulated through the heat exchanger 624 dissipating its heat into the outside atmosphere eventually the air is forced to the exit port (not shown) where a similar circulating fan arranged to suck air from within the heat exchanger unit 624 and out through the exit port into a heavily insulated return air duct 603B is located. As the air is forced down the return air duct it may be kept cold due to heavy insulation applied to the outside of return air duct 603B. Return air duct 603B can be attached on top to equipment platform 610 via quick connect/disconnect coupling. To maintain a good flow rate, the air velocity can be maintained by booster fan located inside of 611B quick connect/disconnect coupling unit on the bottom of each equipment platform, where duct 603B can be attached to the bottom of the equipment platform 610. The downward direction of travel of chilled air is indicated by directional arrow 604B. Once the chilled air has reached the equipment room 601 on the ground, powerful circulating fans 602B located inside 601 equipment room can suck air from the return air duct 603B and push it into underground chilled air supply duct 627 and eventually through thermal storage heat exchanger unit 628 located inside thermal storage unit 629. As the chilled air circulates through thermal storage heat exchanger unit 628 it absorbs heat from thermal storage medium 630 located inside thermals storage tank 629 causing thermal storage medium 630 to cool, freeze or even become super cold depending on the temperature of the returning chilled air which in turn can depend on the maximum altitude the main balloon 101 was ascended to by the controller. 631 is the vent for the chilled air after it has absorbed heat from thermal storage medium 630. It is anticipate that there can still be sufficient cooling in the vented air in which case the air either could be used to provide outdoor cooling or for cooling to a direct forced air type system for cooling of enclosed spaces (e.g., circulation duct work not shown but can be attached to the exhaust vent 631).

Once the thermal storage medium 630 is cooled to desired temperatures it can then be used to supply cooling to paying customers. Supply of cooling to customers can be carried out through a second heat exchanger unit 632 located inside the thermal storage tank 629 and submerged in thermal storage medium 630. After a good heat transfer fluid in second heat exchanger 632 is circulated and charged the chilled liquid can be circulated through cooling supply line 633 to paying customers. Direction of travel of chilled liquid is shown by arrow 634A. At the customer's end cold liquid flowing through cooling supply line 633 can be circulated through each customer's heat exchanger units (not shown) to transfer cooling to interior spaces of that customer. A return line 635 can bring the spent fluid back as shown by directional arrow 634B into the heat exchanger unit 632 to be charged and re-circulated once again to end users. 636 Depicts a cluster of commercial, industrial and residential customers using supplied cooling from this system. Some if not all of the electrical power needed by this system can be supplied by solar panels 637 (photovoltaic installations) or at least one windmill 638 or a plurality of windmills or combination of both photovoltaic and windmills. In addition the facility may be hooked up to the electrical grid for its initial power needs power needs, there after sufficient power may be provided by wind mill propeller 625 and generator combinations and a series of wind mill propeller 619/electrical generators.

Several variations on the system of FIG. 6A and FIG. 6A1 to FIG. 6A-4 are within the scope of embodiments of the present invention. By way of example, and not by way of limitation, FIG. 6B and FIGS. 6B1-6B-4 FIG. 6B and FIG. 6B-1 to FIG. 6B-4 illustrate a system in which a liquid cooling circulation system has been added next to the above-described air circulation system of FIG. 6A. For a given deployment of a lighter than air balloon system to higher altitudes if both air and liquid cooling systems are arranged side by side it can effectively increase the amount of cooling yield for a given deployment of such a system. By way of example, and not by way of limitation, water or a good thermal storage liquid or a mixture of water and a natural or engineered freezing point depression agent can keep the water from freezing once it reaches freezing temperatures at higher altitudes, for the purpose of this discussion the thermal storage liquid may be water. Water is about 784 times as dense as air at sea level giving it a substantial thermal storage capacity. Furthermore, the specific heat of water is also a lot greater than air at a given temperature. Water is therefore, a much better thermal storage medium than air. The drawback to using water is the greater weight of the water, which means that it can take a lot more energy to pump water to higher altitudes as compared to air. To solve this problem renewable energy sources can be used in this system to supply the needed energy. Secondly the proposed system can make use of smaller distance incremental pumping to get the water to the desired altitude. Each equipment platform 610 can have a wind driven or alternatively electrically driven water pump that pumps the water to the next platform instead of using one pump to pump water from the ground to an altitude of, e.g., 15,000 to 20,000 or even 36,000 feet, which is impractical for single stage pumping. Incremental pumping can ease the burden on the main pump as it can only be responsible for pumping the water from one platform to the next, e.g., a distance of say from 100 to 200 feet. A small storage tank may be installed on each platform to take in water pumped from below and store it temporarily, thereby lightening the water pressure and water head in the line and than let the pump on the equipment platform pump the stored water to the next equipment platform, as stated earlier the pumping of the liquid can be from 100 to 200 feet depending on the design.

The ascending liquid lines can be an un-insulated type so as to allow the liquid to gradually cool as it ascends through the lines due to exposure to outside ambient temperatures. Once the water has cooled to the same level as the outside temperature after going through the main liquid heat exchanger unit suspended from the lighter than air balloon the water can descend back to the ground through a highly insulated liquid line to preserve the temperature of the liquid as it encounters higher and higher temperatures at lower altitudes. As the water flows down ward through the highly insulated liquid line it can build up a large amount of kinetic energy and pressure head. At this stage the water may be forced through a power extractor/turbine wheel or water wheel attached to an electrical generator. The pressure head of the water can cause the turbine wheel and the electrical generator to turn producing electrical current, some of the electrical current may be used by various equipments on the equipment platform and the remainder can be transmitted via tethered electrical cable back to the ground. To control or reduce the force of the falling water it can be directed to flow through a small water storage tank on the equipment platform with built in flow regulator valve to control the flow of the water to the liquid line below it in a similar incremental down ward flow as incremental pumping done on the ascending line.

Now looking at FIG. 6B, only the water components shall be discusses as the air cooling system components are identical to FIG. 6A and have been discussed before. Main water pump 640 can pump water or a good thermal storage liquid up the un-insulated and super strong yet ultra light weight flexible liquid transmission line 641A (e.g., a hose made of an extruded rubber or similar material jacketed with a layer of woven material similar in construction to the material of a fire fighter's hose can be utilized). Use of an un-insulated line can allow for dissipation of heat from the water to take place as the altitude increases and the temperature decreases. Liquid supply line can be connected to each equipment platform via a quick connect/disconnect coupling 643A, located at bottom of equipment platform 610. Each subsequent section of liquid supply line above it can be connected at the top of equipment platform 610 via a top quick connect/disconnect coupling 645A.

In between the bottom and top quick connect/disconnect couplings 643A, 645A is a liquid booster pump 644 located on each equipment platform 610. As the water coming up through liquid supply line 641A reaches the equipment platform it can be deposited into a temporary liquid storage tank 643C located on equipment platform 610, thereafter, once the tank is full or almost full a small liquid booster pump 644, located on platform 610 can engage and pump the liquid up through the liquid transmission line above that equipment platform 610 on to the next equipment platform above it and so on. The booster pump 644 can pump the water along through the next line above it to ensure there is no pressure droop as the main pump does not have the necessary power to pump cooling liquid all the way to the desired altitude what may be as high as 15,000, 20,000 or even 36,000 feet or even higher. Stepped pumping to temporary liquid holding tank 643C and placement of booster pumps 644 along the liquid supply line 641A can ensure the smooth pumping of liquid all the way to the top. The liquid booster pumps 644 can be powered by drive shafts or alternatively belts and pulleys (not shown) driven by a gear box 620 connected to the windmill propeller 619 which in turn is connected via a shaft to power extractor/electric generator 620B. Alternatively the booster pump 644 may be driven by its own dedicated smaller windmill propeller attached directly to it (not shown) or by an electric motor (not shown).

Water traveling up the supply line as indicated by arrow 642A is gradually cooled as a result of its heat being absorbed through un-insulated water line to the outside atmosphere. Liquid booster pump 644A on first equipment platform 610A can pump the water to the next higher equipment platform 610B through water line 641A where the water pump 644B located on that platform can pump the water up through the next water line 641A above it and so on. At maximum altitude the water enters the water heat exchanger unit (not shown) located inside the main heat exchange unit 624, where it dissipates its remaining heat into surrounding atmosphere. Water may be pumped through the liquid heat exchanger unit by water pump (not shown) located inside the heat exchanger unit 624.

Water pumps may be powered via belts and pulleys or drive shaft hooked up to a gear box (not shown) attached to windmill propeller 625 on the outside of heat exchanger unit 624. Alternatively a smaller dedicated wind mill propeller (not shown) may be attached directly to the water pump inside 624 to drive the water pump. After going through heat exchanger unit 624 the chilled or super cold water can start its return trip back to the ground via return lines 641B a heavily insulated and the top most liquid return line, upon reaching the first equipment platform the liquid line 641B is hooked up to a turbine wheel and electrical generator unit/power extractor 646 via a quick connect/disconnect coupling 645B the force and weight of the falling water flowing through the water line 641B can cause the turbine wheel and generator 646 to turn producing electrical current that may be transmitted to the ground via an electrical cable 607. A directional arrow 642B indicates the direction of liquid flow in liquid return line 641B, some of the power can be used by various equipments on the equipment platform 610. 643B is the bottom quick connect/disconnect coupling used to attach liquid return line 641B to the bottom of equipment platform 610. To slow the rate of flow and the pressure head of the falling water in line 641B and all subsequent liquid return lines below it, after the water leaves the turbine wheel and before it gets to he next turbine wheel below it via liquid supply line 641B, it may be temporarily stored in a storage tank 643D and released slowly by a flow regulating valve in a staggered fashion to the line below it and so on. After the chilled or super chilled water arrives at ground level the flow rate may be increased by a bigger and a larger diameter insulated water line. At the bottom of the run the water can go through yet another bigger turbine wheel hooked up to a bigger electrical generator/power extractor 647 as compared to the smaller turbine wheel and generator combination 646 on equipment platform 610. Having gone through the last turbine wheel on the ground the water can enter a chilled water heat exchanger unit 648 located inside the thermal storage unit 629 and submerged in thermal storage medium 630. As the chilled or super cold water returning from higher altitudes circulates through the liquid heat exchanger 648 it can absorb the heat from the thermal storage medium 630 causing it to get cold or super cold or become solid super cold ice depending on the temperature of the returning water from high altitudes and if freezing point depression agents have been added to thermal storage medium 630. The water in the liquid thermals storage heat exchange can start its journey back to higher altitudes once it warms up as a result of going through the heat exchanger 648. Once the thermal storage medium 630 has been sufficiently cooled it is ready to start the supply of chilled water or other good heat transfer liquid or even chilled air through distribution ducts (not shown) to paying customers through distribution lines discussed earlier in description of FIG. 6A. FIGS. 6B-1 AND 6B-2 are top and side views of balloon clusters and equipment platform of FIG. 6B, whereas, FIGS. 6B-3 and 6B-4 are top view and bottom view of equipment platform of FIG. 6B.

FIG. 6C shows a system which is similar to system as depicted in FIG. 6B where the air circulating system has been removed and only the water or liquid circulating system is left in place. FIG. 6C-1 is a top view of the balloon cluster of FIG. 6C. FIG. 6C-2 is a side view of the balloon cluster and equipment platform of FIG. 6C. FIGS. 6C-3 and 6C-4 are bottom view and top view of equipment platform of FIG. 6C. Description of this system is otherwise identical to what was described above in description of FIG. 6B.

FIG. 6D is a depiction of a cooling system similar to the system depicted in FIG. 6A, 6B or 6C except the balloon clusters have been replaced with a single larger blimp type of a balloon having a rigid or a semi-rigid design. As shown in FIG. 6D, the main balloon 101 is replaced with a large blimp 660, with stabilizing fins in the back 661. The small balloon series 614 have been replaced with smaller side-by-side blimps 662-1-1 and 662-1-2, where -1 after the 662 denotes blimps of the first equipment platform the -1 after 662-1 denotes the first of the 2 sided by side blimps. Therefore, 662-2-1 denotes the first blimp of the second equipment platform above the first one and 662-2-2 denotes second blimp of the second equipment platform and so on. In this example there are 10 such blimps (only three of which are shown), with the tenth blimp denoted 662-10-1 whereas, the second blimp of each equipment platform is hidden from view behind the first one.

In another embodiment a combination of a main blimp and a large kite attached to the top of the blimp maybe used, whereby, the kites adding greatly to the lifting capacity of the blimp, the two working in concert with each other. The smaller blimps 662-1-1 and 662-1-2 are attached to the equipment platform by arms 664A, B, C and D and each blimp is connected to each other with braces 666A in the front and a second brace 666B in the back. In this arrangement, equipment platform of the system of FIG. 6D is slightly smaller in size as compared to the systems in FIGS. 6A, 6B and 6C but having nearly identical equipment. The equipment platform may be attached to 2 smaller blimps 662-1-1 and 662-1-2 or a single bigger blimp having pass-through opening as can be described and discussed later. FIG. 6D-1 is a top and cut away view of a side-by-side arrangement of 2 blimps supporting an equipment platform of FIG. 6D. This set of side-by-side blimps 662 are similar in function to the individual equipment platform balloons 614A, 614B, 614C, 614D, 614E and 614F of FIGS. 6A, 6B and 6C.

FIG. 6D-2 is a side view of the aircraft (blimp 662) and equipment platform of FIG. 6D. The structure and function of the frame 666A and 666B in this system is similar to FIGS. 6A, 6B and 6C. FIGS. 6D-3 and 6D-4 are dorsal and ventral views respectively of equipment platform of FIG. 6D with identical equipment as in the equipment platform of FIGS. 6A, 6B and 6C except for a smaller size due to a different shape.

FIG. 6D-5 is a different type of a slightly larger blimp 663 as compared to 662 type of a blimp that can be attached to equipment platform of FIG. 6D to keep it aloft. In this design pass-through opening 665 is constructed into the blimp to allow pass through of various ducts, liquid lines, tether, gas supply, and return lines as well as electrical cable from the bottom to the top. Gas supply and return line 608 and 609 respectively can be attached to a quick connect/disconnect coupling some were on the blimp (not shown) to allow inflation and deflation of the blimp by lighter then air gas using “T” fittings and solenoid operated valves, “T” fittings similar to the ones used to attach gas supply and return to gas distribution manifold 618 on equipment platform 610 in FIG. 6A-3 and 6A-4 described earlier. In this arrangement gas distribution manifold is eliminated completely only “T” and solenoid operated valves are used to inflate or deflate the blimp to control its buoyancy.

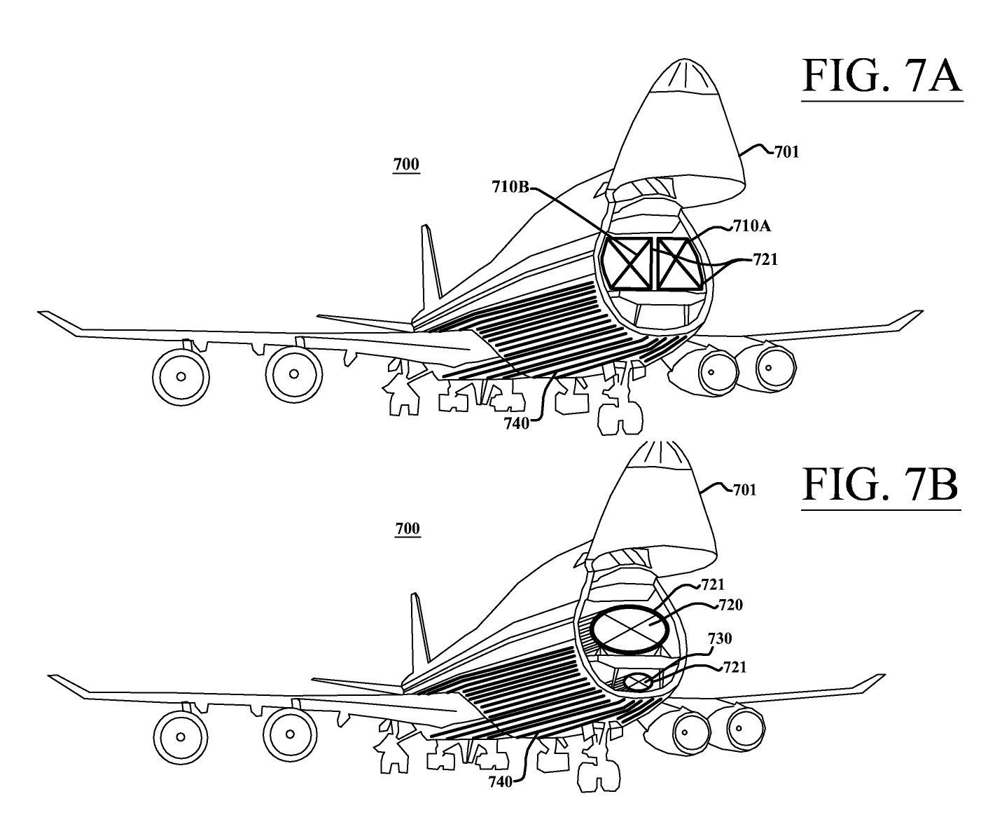

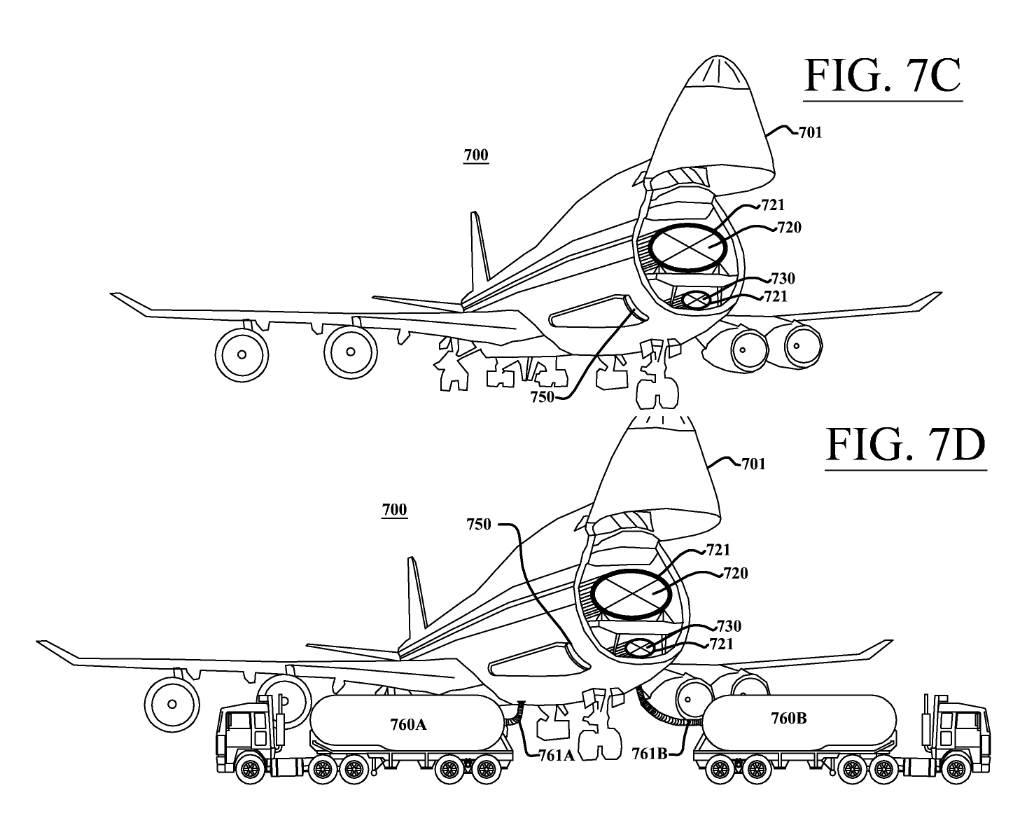

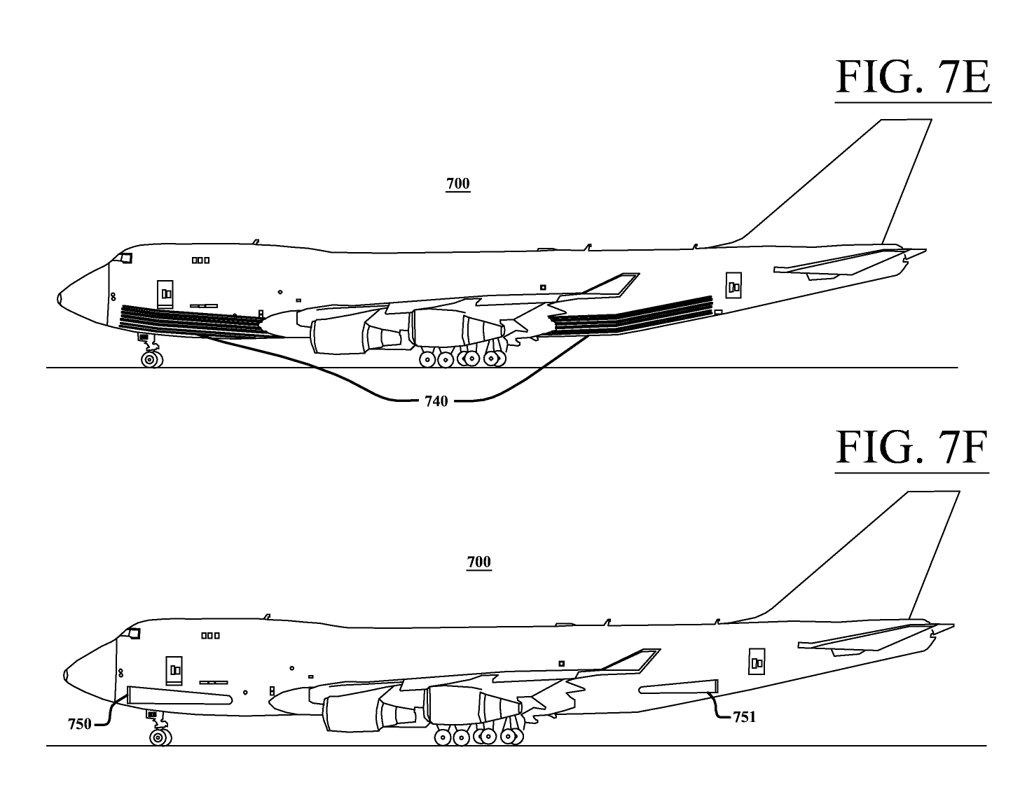

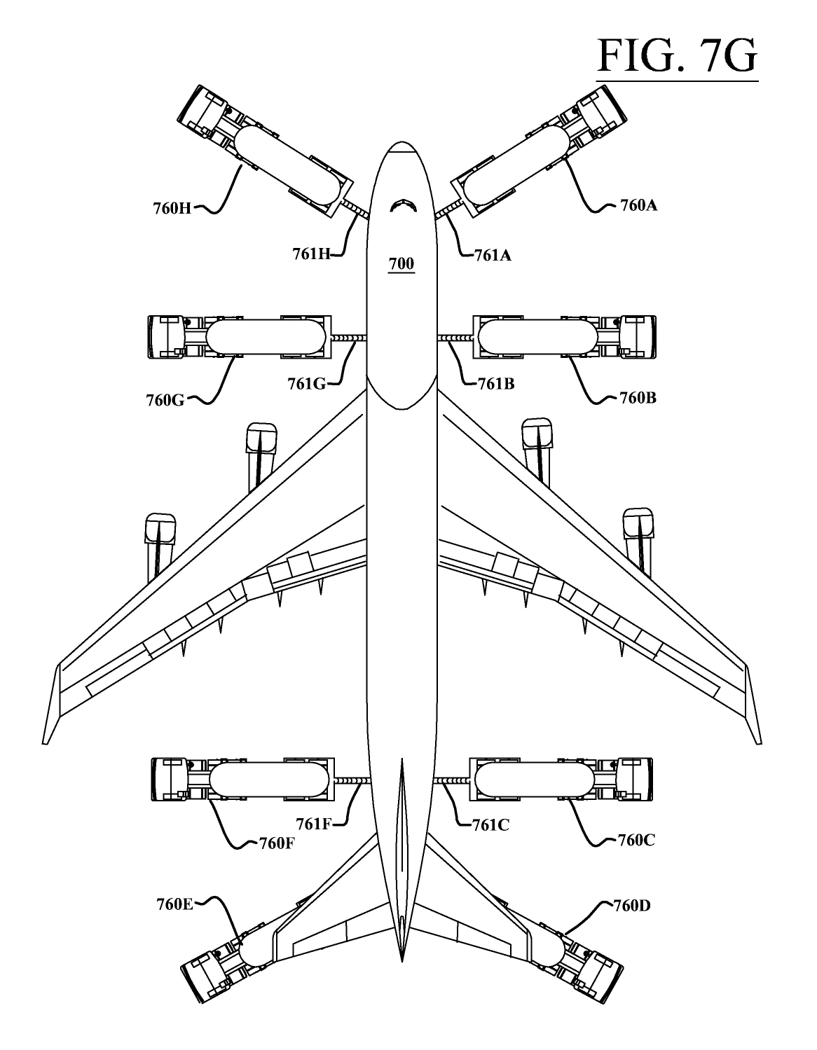

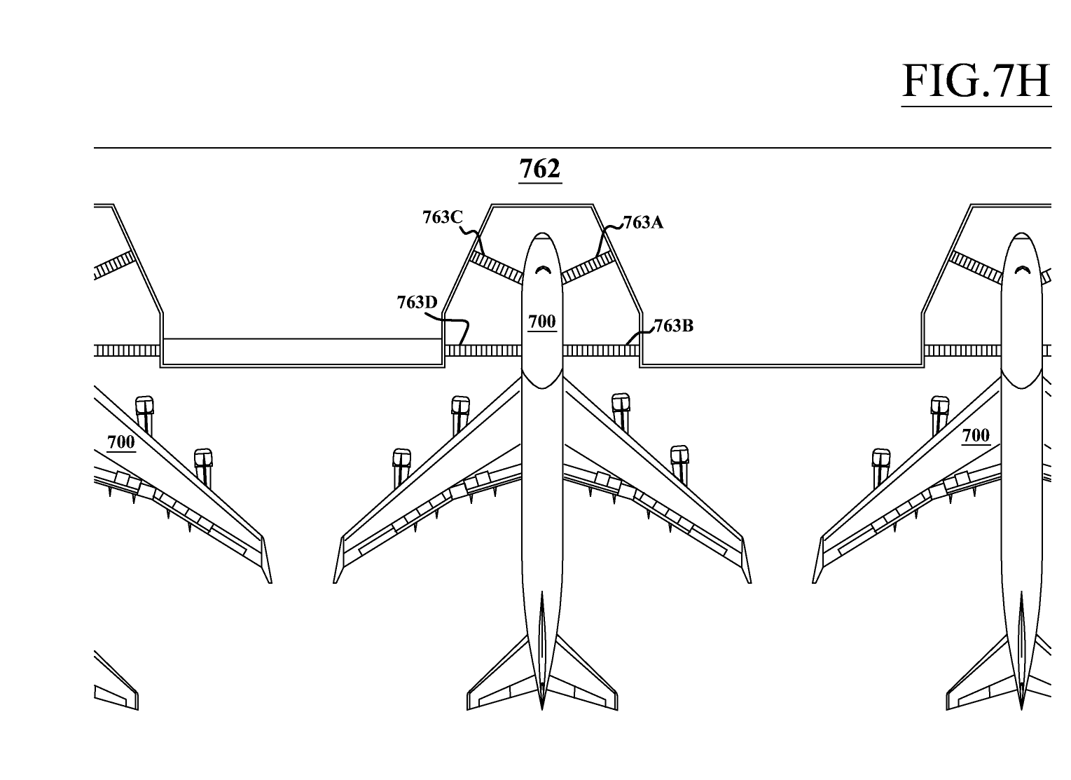

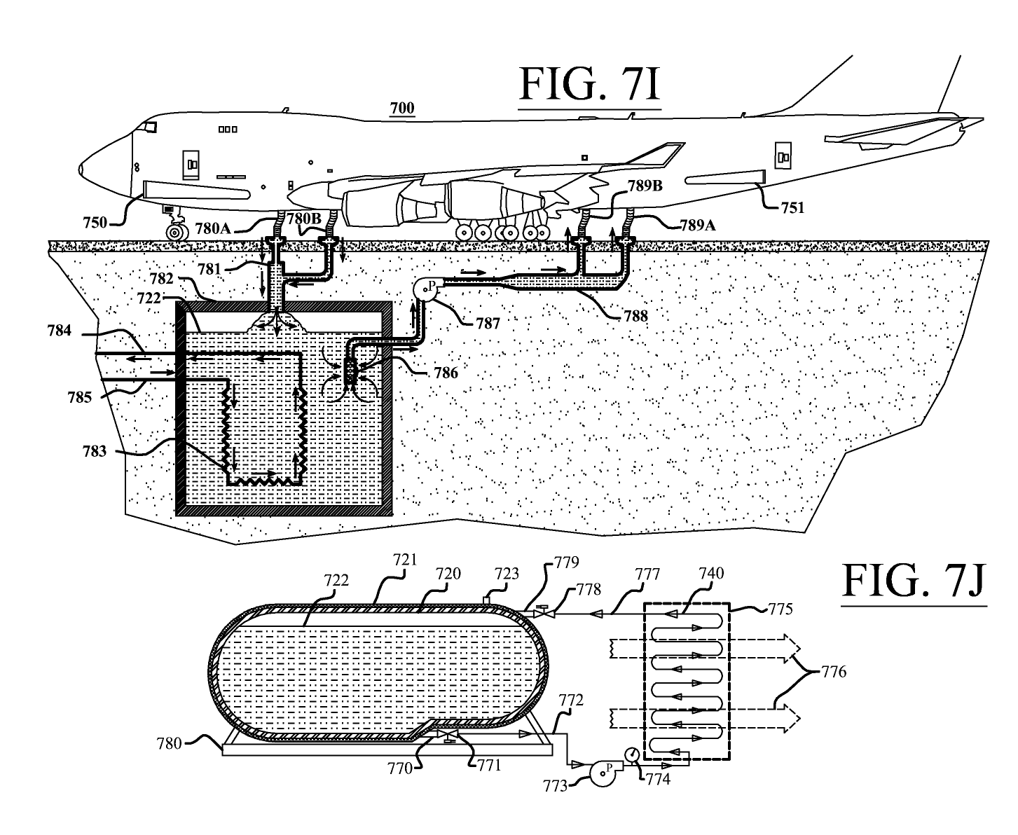

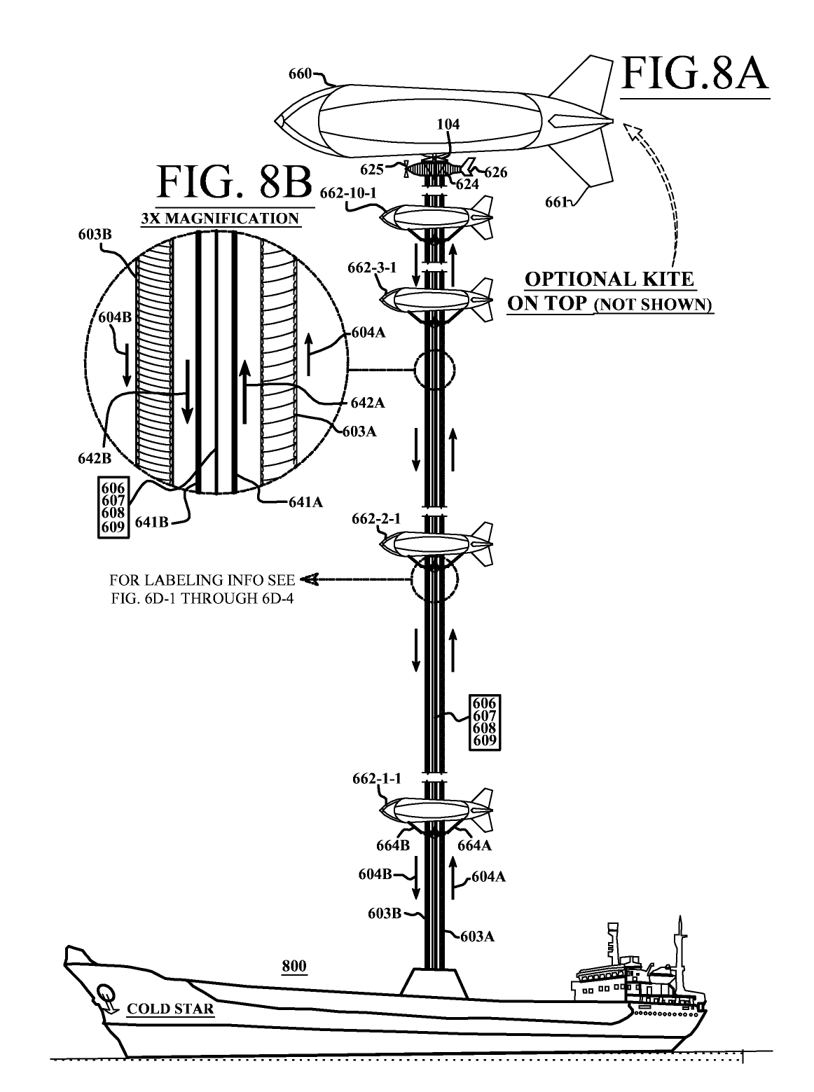

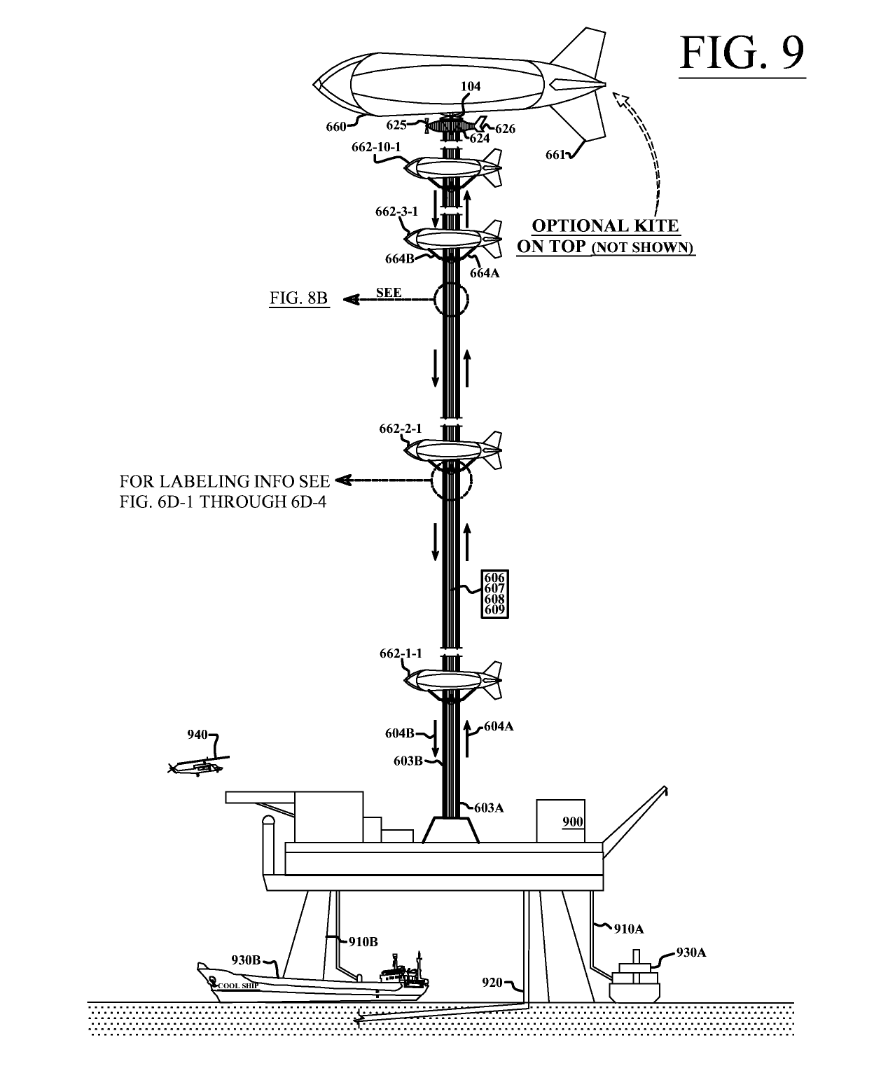

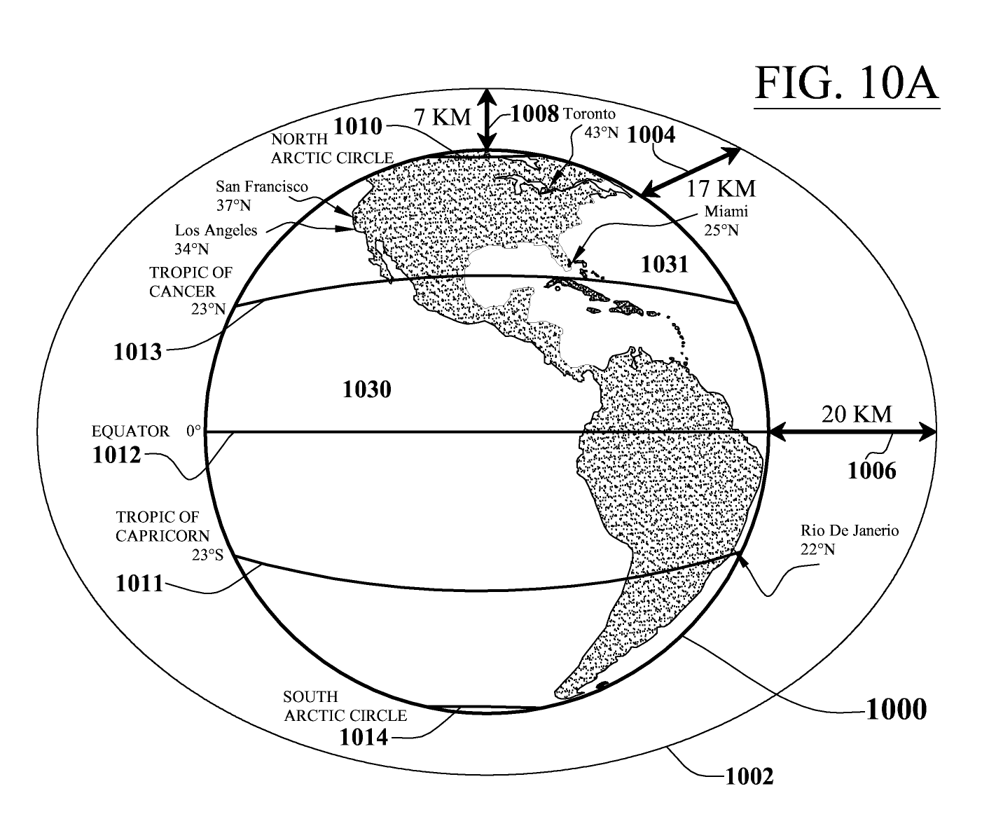

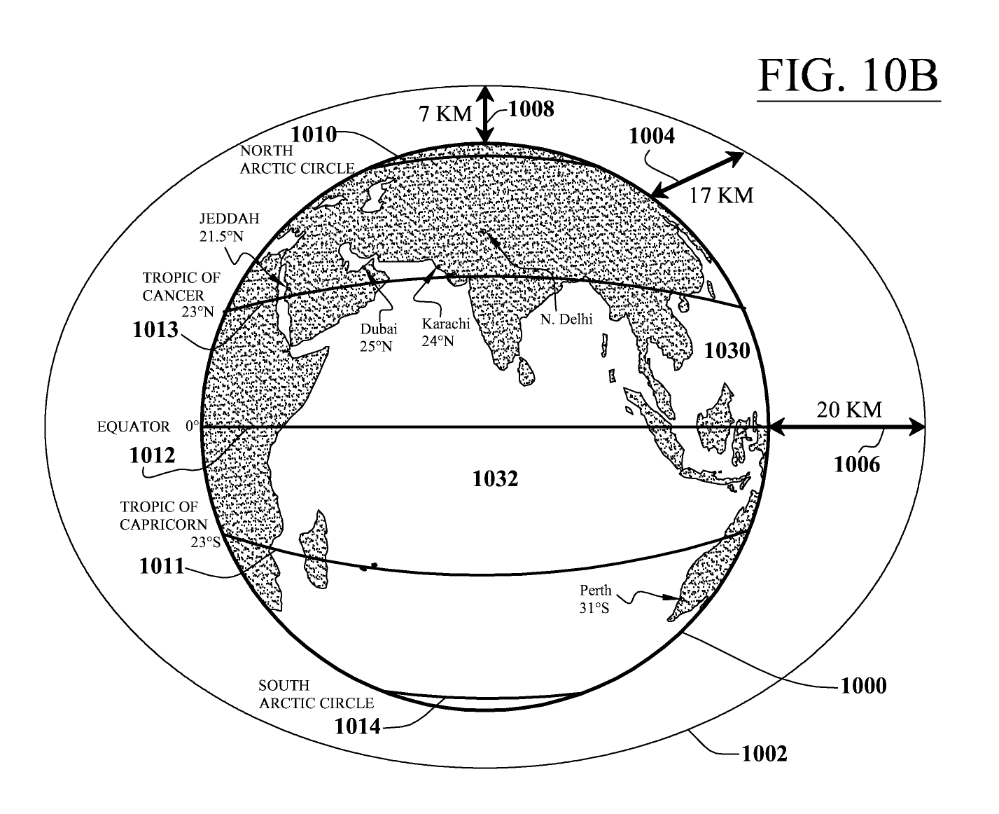

FIGS. 7A-7C are perspective views illustrating alternative freighter aircraft with built in cooling systems. As shown in these figures, a freighter aircraft 700 includes a front cargo door 701, which is in open position, alternatively freighter aircraft may not have front cargo door and may instead have a cargo door located at another portion of the aircraft or no cargo door at all.

As shown in FIG. 7A, a series of palletized thermal storage container 710A, 710B, 710C and so on for containing thermal storage fluid or chilled liquid are located on main deck inside of the front cargo door 701. The palletized storage containers 710s can be either fixed or removable. The palletized storage containers 710s are insulated from outside atmosphere with an insulating layer 721. Alternatively storage containers may be of vacuum flask type (not shown) with insulating layer on the outside for added insulating qualities. The insulating layer 721 is preferably made of aerogel or any other good light weight insulating material. A heat exchanger 740 is built at the bottom of the aircraft 700 with pipes exposed to outside atmosphere. The heat exchanger 740 can be either internal or external type depending on the design. The heat exchanger 740 is connected to the palletized thermal storage containers 710s via piping so the thermal storage liquid in the container can circulate through the heat exchanger to be cooled and back into the palletized container 710s and 720s. Additional palletized containers 710s can be located on the lower deck of the freighter aircraft (not shown). Alternatively to circulating the thermal storage liquid from the thermal storage tanks located on board the aircraft through heat exchanger piping, outside air may be circulated through piping and into heat exchanger located inside each of the thermal storage containers (similar to the coiled piping used in FIG. 2s but instead of circulating liquid in the lines outside air can be passed through, thereby, the super cold outside air absorbing the heat of the thermal storage liquid and eventually venting the absorbed heat to the outside atmosphere upon the same exiting the aircraft (not shown).

In an alternative embodiment, the freighter aircraft 700 may include two thermal storage containers inside of the front cargo door 701. As shown in FIG. 7B, a thermal storage container 720 is on the main deck and a thermal storage container 730 is located on lower deck inside of the front cargo door 701. The thermal storage container 720 and 730 can be either fixed or removable. The thermal storage containers 720 and 730 are insulated from outside atmosphere with an insulating layer 721 or can be of a vacuum flask type with insulating layer 721. Similar to FIG. 7A, a heat exchanger 740 is built either internally or externally at the bottom or any other suitable location of the aircraft 701 with pipes or fins exposed to outside atmosphere facilitating for faster dissipation of heat.

FIG. 7C is same as FIG. 7B with the exception that instead of an external heat exchanger unit on the bottom of the aircraft 700 there is an “air scoop” 750 located on the bottom of each side of the aircraft designed to ingest ram air as the aircraft moves forward to enable the cold outside air to flow over the internal heat exchanger located inside the aircraft to cool the thermal storage liquid stored in containers in side of the aircraft as it is circulated through the heat exchanger unit and back into the containers.

FIG. 7D is same as FIG. 7B but in this embodiment external heat exchanger unit is replaced on the aircraft with a ram air, “air scoop” 750 of FIG. 7C to supply chilled outside air to internal heat exchanger unit. Also tanker trucks 760A and 760B are shown parked along side the aircraft 700 and are in the process of off loading super chilled thermal storage liquid onto tanker trucks 760A and 760B via discharge hoses 761A and 761B. It must be pointed out that tanker trucks may also fill up the containers in the aircraft when and as needed.

FIG. 7E is a side view of the freighter aircraft 700 having an external heat exchanger 740 built at the bottom of the aircraft as shown in FIGS. 7A-7B.

In an alternative embodiment, the heat exchanger 740 is replaced with a ram air scoop for internal heat exchanger, which is shown in FIG. 7C. FIG. 7F is a side view of the freighter aircraft 700 having a ram air scoop 750 built at the bottom of the aircraft as shown in FIG. 7C. At the back of the aircraft is an exhaust port 751 on either side of the fuselage to allow ram air ingested through air scoop 750 to exit the aircraft after it has gone through the internal heat exchanger unit.

FIG. 7G is a top view illustrating the loading and unloading of thermal storage liquid between the aircraft 700 and tanker trucks 760A-760H through hoses 761A-761C and 761F-761H on the ground.

FIG. 7H is a top view showing several aircraft 700 parked on the ground at gate of a building 762 for transferring the thermal storage liquid through extendable booms 763A-763D into the terminal building storage tank (not shown). It must be pointed out that loading and unloading of thermal storage liquid onto aircraft can be through gravity feed to speed up the loading and unloading operation by pumped or pressurized system.

FIG. 7I is a side view illustrating the transferring of the thermal storage medium 722 between an aircraft 700 and a under ground thermal storage medium holding tank 782. The liquid 722 can be water with freezing point depression agent or ethylene glycol or the likes. The liquid 722 is unloaded from the aircraft 700 through unloading hoses 780A, 780B attached to the aircraft at one end and to the ground receptacle at the other end. The liquid 722 then enters an under ground supply line 781 and discharged into the thermal storage medium holding tank 782. A heat exchanger 783 located inside of the thermal storage medium holding tank 782 is submerged in the liquid 722. Supply line 784 is from the heat exchanger unit 783 is used to supply chilled liquid to end users. Return line 785 is from the end user back to heat exchanger 783.

The warm liquid 722 from the holding tank 782 is loaded into the aircraft 700 by an evacuation line 786. Pump 787 pumps the liquid 722 from under ground tank 782 to above ground receptacle through the pipes 788. The liquid 722 is loaded into the aircraft 700 by hoses 789A, 789B. 750 is the ram air scoop to ingest outside air into the aircraft and 751 is the exhaust port for the ingested air. Pressurization system (not shown) located on the ground or inside the aircraft can be used to speed up the loading or unloading of the liquid from the aircraft.

FIG. 7J is a schematic of thermal storage liquid storage tanks, heat exchanger unit and associated pumps and piping that can be used on board the freighter aircraft of the types shown in FIG. 7A through FIG, 7E schematically illustrating the heat transfer between an external or internal heat exchanger unit 775 located on board the freighter aircraft and a thermal storage medium tank 710 or 720 of the type depicted in FIG. 7C and FIG. 7D respectively. As shown in FIGS. 7A-7CC and FIG. 7D, the tank 710 or 720 is insulated from the outside atmosphere with an insulating layer 721. A pressure relief valve 723 is built on top of the tank 710 or 720 (720 shown). The thermal storage liquid 722 is unloaded from the container 710 or 720 through a valve 771 that is connected to the tank 710 or 720 via an exhaust manifold 770 at one end and to the main supply line from the tank 772 going to the heat exchanger at the other end. Circulation pump 773 on board the aircraft 700, is controlled by a pressure/temperature gauge 774, and can pumps the liquid 722 into the heat exchanger unit 775 containing individual grid piping 740 either on the inside or the outside of the aircraft depending on the design. Alternatively, the pump 773 may be controlled by the controller some where on board the aircraft. The thermal storage liquid 722 is returned back to the thermal storage tank 710 or 720 through a return line 777 and a valve 778 which is attached to an inlet manifold 779 after it has passed through the piping 740 located inside the heat exchanger unit 775 where it has sufficiently cooled as a result of outside air 776 passing over the internal or external heat exchanger unit thus absorbing and carrying away its heat. 780 is the skid of the tank to facilitate easy handling and movement as needed.

FIG. 8A is a depiction of a similar cooling system as depicted in FIG. 6D attached to and deployed from a vessel 800 on the ocean or other large body of water. In this embodiment, the thermal storage tank (not shown) is located on board the vessel 800. By way of example, ten visible aircrafts (blimps) 661-1-1 to 661-1-10 are connected together between the top main aircraft (blimp) 660 and the vessel 800 with an equipment platform similar to the type depicted in FIG. 6D-3. FIG. 8B is a magnified side view illustrating the tether 606 as well as electrical cable 607, gas supply line 608, gas return line 609 and the air supply and return ducts 603A and 603B as well as liquid supply and return lines 641A and 641B. Directional arrows depicting direction of movement of air and liquid in their respective lines are indicated by 604A, 604B, 642A and 642B.

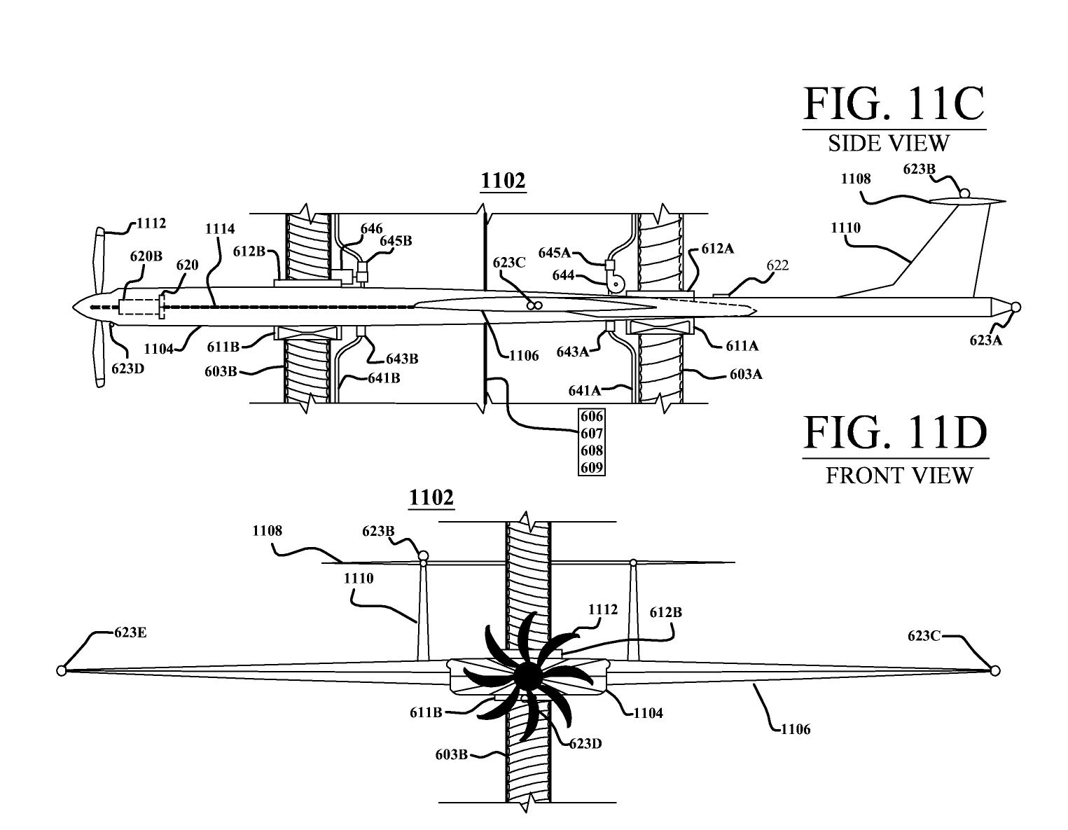

FIG. 9 is a depiction of a cooling system similar to that depicted in FIG. 6D located on an ocean platform 900 that is similar to an oil drilling platform. In this embodiment, a thermal storage tank (not shown) is located in the ocean platform 900. Heat transfer fluid in a thermal storage tank (not shown) on board the platform 900 can be cooled or super cooled as a result of chilled air or chilled water or both coming down from high altitude down the return air duct 603B and chilled liquid return line 641B. The heat transfer fluid can be supplied and returned between the platform and ships 930A, 930B by supply and return pipes 910A, 910B. Alternatively, the heat transfer fluid can be supplied and returned between the platform and the land by a clustered supply and return line 920 connected to the platform 900, going to the ocean floor and eventually to land. 940 is a helicopter landing on the platform 900 to transport men and material to and from the platform.

FIGS. 10A-10B, are images of the Earth 1000 with a troposphere 1002, which is the lowest portion of Earth's atmosphere. The troposphere contains approximately 75% of the atmosphere's mass and 99% of its water vapor and aerosols. The average depth of the troposphere is approximately 17 km (11 mi) in the middle latitudes as shown at 1004. It is deeper in the tropical regions, up to 20 km (12 mi) as shown at 1006, and shallower near the poles, at 7 km (4.3 mi) in the summer months as shown at 1008, and indistinct in winter. The lowest part of the troposphere, where friction with the Earth's surface influences air flow, is sometimes referred to as the planetary boundary layer. This layer is typically a few hundred meters to 2 km (1.2 mi) deep depending on the landform and time of day. At the border between the troposphere and stratosphere, called the tropopause, is a temperature inversion. (see http://en.wikipedia.org/wiki/Troposphere). FIGS. 10A-10B also illustrates the Arctic Circle and Antarctic Circle 1010 and 1014 respectively, Tropic of Capricorn 1011, equator 1012, Tropical of Cancer 1013, Pacific Ocean 1030, Atlantic Ocean 1031 and Indian Ocean 1032.

As may be seen from FIG. 10, one may have to go higher at lower latitudes as opposed to mid latitudes where the desired low temperatures may be reached at much lower altitudes. If a majority of Earth's population resides at mid latitudes atmospheric lapse rate cooling could be advantageous since cooling equipment need not ascend too high to reach the desired temperatures.

A number of variations on the above-described embodiments are within the scope of embodiments of the present invention. For example, as illustrated in FIG. 11A, a system like that shown in FIG. 6A may use balloons that surround the cooling fluid supply ducts 603A and return ducts 603B. Air ducts and liquid pipes are enclosed inside of a bigger flexible ducts/elongated balloon or bladder 1101 filled with helium or other lighter than air gas instead of having balloons at the top of each section of duct to lift the section under it, essentially making it a self-lifting section of duct, piping, lines etc. In addition to the duct 1101 a new self lifting equipment platform 1102 (to be discussed later) may be used as the link between joining ducts, lines, pipes etc

In addition, the system illustrated earlier, now looking at FIG. 11B equipment platforms of the types depicted in FIG. 6 through FIG. 9, may be replaced with a new self-lifting equipment platforms 1102, having a body or fuselage 1104 in the shape of an airfoil to which wings 1106 and horizontal and vertical stabilizers 1108, 1110 are attached in a configuration similar to that of a conventional aircraft or a glider. As the wind at higher altitudes passes on the top and bottom surfaces of the platform enough lift can be generated by the platform 1102 to not only carry its on weight but to carry some or all of the weight of the duct section below it. A propeller 1112 attached to the front of the aircraft-like platform 1102 can be turned by the wind. The propeller 1112 can be attached to a mechanical gear box 620 and an electrical generator/power extractor 620B similar to the one used on platform 610 of FIG. 6A-3 to supply power to various equipment i.e. fans, pumps etc, whereas, the electrical generator can supply electrical power to power lights, navigation equipment, control surfaces actuators, communication equipment, solenoid operated valves and any other equipment that may need electrical power. Drive shaft 1114 can be connected at one end to gear box 620 to transmit extracted power from wind mill propeller 1112 to various equipment as well as to booster fans located in housing 611A and 611B. A substantial amount of excess electrical power can be sent to the ground via electrical cable 607 attached to tether 606. The body 1104 may have all of the control surfaces (e.g. ailerons, slats, horizontal and vertical stabilizers, elevators, flaps, spoilers, rudders etc.,) (not shown) used on a conventional aircraft to control its movement via a signal from the ground from a live operator or an electronic controller, signal can be transmitted via hard wires (not shown) or wireless means (not shown) to receiving equipment on board 1102. Alternatively instead of a propeller, ducted fans similar to jet or turbofan engines can be use to harness the power of the wind, as the high altitude high speed winds enters the nacelle the wind can cause the fan blades to turn, thereby turning the shaft they are attached to which in turn could turn an electrical generator or power extractor to harness the energy of the winds. At least one or a plurality of propellers or turbofan type of power harnessing unit may be installed on each 1102, similar to a twin, tri or four engine aircraft (now shown). As seen in FIG. 11B, FIG. 11C, the self lifting equipment platform 1102 may contain many of the features of the equipment platform 610 of FIGS. 6A, 6B,6C and 6D which may operate as described above.

Embodiments of the present invention may suitably comprise, consist of, or consist essentially of, any of the element (the various parts or features of the invention as described herein and their equivalents. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

The reader's attention is directed to all papers and documents which are filed concurrently with this specification and which are open to public inspection with this specification, and the contents of all such papers and documents incorporated herein by reference.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for cooling a heat transfer fluid, comprising:
a) ascending a heat transfer fluid to predetermined altitude above a ground level where a temperature of the atmosphere is lower than a temperature at the ground level;
b) cooling the heat transfer fluid to a predetermined temperature that is lower than a temperature at the ground level by exchange of heat between the heat transfer fluid and the atmosphere; and
c) descending the cooled heat transfer fluid to the ground level while inhibiting heat transfer with the atmosphere tending to warm the cooled fluid.

2. The method of claim 1, wherein step a) comprises:
pumping the heat transfer fluid to a heat exchanger unit located on a tower.

3. The method of claim 2, wherein step c) comprises:
transferring the heat transfer fluid from the heat exchanger unit to a thermal storage container located on the ground level.

4. The method of claim 1, wherein step a) comprises:
ascending a heat exchanger unit with balloons filled with a gas lighter than air and pumping the heat transfer fluid to a heat exchanger unit.

5. The method of claim 4, wherein step c) comprises:
transferring the heat transfer fluid from the heat exchanger unit to a thermal storage container located on the ground level.

6. The method of claim 4, wherein ascending a heat exchanger unit with the balloons filled with a gas lighter than air and a kite attached at the top of the balloons.

7. The method of claim 1, wherein step a) comprises:
ascending a heat exchanger unit with aircrafts; and
pumping the heat transfer fluid to a heat exchanger unit.

8. The method of claim 7, wherein step c) comprises:
transferring the heat transfer fluid from the heat exchanger unit to a thermal storage container located on the ground level.

9. The method of claim 7, wherein ascending a heat exchanger unit with the aircrafts and a kite attached at the top of the balloons.

10. The method of claim 1 further comprising extracting energy as the heat transfer fluid ascends using a tether coupled to a generator and to a mechanism that ascends the heat transfer fluid.

11. The method of claim 1 is performed in a freighter aircraft with a built in heat exchanger unit and a thermal storage container.

12. A cooling system comprising:
means for ascending a heat transfer fluid to a to predetermined altitude above a ground level where a temperature of the atmosphere is less than a temperature at the ground level;
means for descending the heat transfer fluid back to the ground level while inhibiting heat transfer with the atmosphere tending to warm the cooled fluid;
a heat exchanger unit coupled to the means for ascending and descending the heat transfer fluid, wherein the heat exchanger configured to cool the heat transfer fluid by heat exchange with the atmosphere; and
a thermal storage container configured to receive the cooled heat transfer fluid.

13. The system of claim 12, wherein the thermal storage container is located on the ground level.

14. The system of claim 13, wherein the means for ascending and descending the heat transfer fluid comprises an ultra tall tower with the heat exchanger located along the tower.

15. The system of claim 14, wherein the means for ascending and descending the heat transfer fluid further comprises one or more supply lines and return lines connected between the heat exchanger and the thermal storage container for transferring the heat transfer fluid.

16. The system of claim 13 further comprising an aircraft configured to support the tower from above.

17. The system of claim 16, wherein the means for ascending and descending the heat transfer fluid comprises balloons filled with a gas lighter than air.

18. The system of claim 17, wherein the means for ascending and descending the heat transfer fluid comprises a main balloon and balloon clusters, wherein the main balloon is located at a topmost level of the tower.

19. The system of claim 18 wherein the means for ascending and descending the heat transfer fluid further comprises a kite attached on top of the main balloon.

20. The system of claim 17 wherein the balloon clusters include one or more balloons that surround the supply lines and return lines.

21. The system of claim 17 wherein the aircraft holding the thermal storage container is located between the main balloon and the balloon clusters.

22. The system of claim 21 further comprising supply lines and return lines connected between the heat exchanger and the thermal storage container for transferring the heat transfer fluid.

23. The system of claim 16 wherein the means for ascending and descending the heat transfer fluid comprises an aircraft, having a body or fuselage in the shape of an airfoil to which wings and horizontal and vertical stabilizers are attached to the aircraft.

24. The system of claim 23 further comprising a windmill propeller or ducted fan attached to the aircraft, wherein the windmill propeller or ducted fan is mechanically coupled to an electrical generator, whereby electricity is generated when the windmill propeller or ducted fan is turned by the wind

25. The system of claim 23, wherein an aircraft holding the thermal storage container is located underneath of a top aircraft.

26. The system of claim 25 wherein the means for ascending and descending the heat transfer fluid further comprises a kite attached on top of the top aircraft.

27. The system of claim 25 further comprising supply lines and return lines connected between the heat exchanger unit and the thermal storage container for transferring the heat transfer fluid.

28. The system of claim 12, wherein means for ascending and descending the heat transfer fluid comprises a freighter aircraft.

29. The system of claim 28, wherein the heat exchanger unit is built at a bottom of the freighter aircraft with pipes for circulating the fluid exposed to the atmosphere.

30. The system of claim 29, wherein the thermal storage container comprises palletized thermal storage container located on a main deck of the aircraft.

31. The system of claim 30, wherein the thermal storage container comprises palletized thermal storage container is fixed.

32. The system of claim 30, wherein the thermal storage container comprises palletized thermal storage container is removable from the aircraft.

33. The system of claim 30, wherein the thermal storage container comprises palletized thermal storage container is insulated by an insulating layer.

34. The system of claim 33, wherein the insulating layer comprise aerogel.

35. The system of claim 29, wherein the thermal storage container comprises a first thermal storage container located on a main deck of the freighter aircraft and a second thermal storage container located on a lower deck.

36. The system of claim 35, wherein the first and second thermal storage containers are insulted by an insulating layer.

37. The system of claim 36, wherein the insulating layer comprises an aerogel.

38. The system of claim 12 further comprising a generator having a shaft and a tether wound around a reel connected to the shaft, wherein an end of the tether is connected to the means for ascending the heat transfer fluid such that the reel turns the generator shaft as the heat transfer fluid ascends.

39. The system of claim 12, wherein the means for ascending or descending the heat transfer fluid comprises one or more balloons filled with a gas lighter than air.

40. The system of claim 39 wherein the means for ascending and descending the heat transfer fluid further comprises a kite.

41. The system of claim 39, wherein the means for ascending and descending the heat transfer fluid comprises a main balloon and one or more balloon clusters.

42. The system of claim 41 further comprising supply lines and return lines connected between the heat exchanger unit and the thermal storage container for transferring the heat transfer fluid, wherein the balloon clusters include one or more balloons that support the supply lines and return lines.

43. The system of claim 12, further comprising a windmill propeller or ducted fan attached to the means for ascending or descending the heat transfer fluid.

44. The system of claim 43 wherein the windmill propeller or ducted fan is mechanically coupled to an electrical generator, whereby electricity is generated when the windmill propeller or ducted fan is turned by the wind.
